(19) United States
(12) Patent Application Publication
(10) Pub. No.: US 2025/0056669 A1
(43) Pub. Date: Feb. 13, 2025

(54) HANDLING MULTICAST/BROADCAST SERVICE AUTHORIZATION FOR INBOUND AND OUTBOUND ROAMERS

(71) Applicant: NOKIA TECHNOLOGIES OY, Espoo (FI)

(72) Inventors: Philippe GODIN, Versailles (FR); Rajesh Babu NATARAJAN, Bangalore (IN); Bruno LANDAIS, Pleumeur-Bodou (FR); Mohamed Amin NASSAR, Munich (DE); Horst Thomas BELLING, Erding (DE); Ugur Baran ELMALI, Munich (DE)

(21) Appl. No.: 18/793,564

(22) Filed: Aug. 2, 2024

(30) Foreign Application Priority Data
Aug. 9, 2023 (GB) 2312169.2

(51) Int. Cl. H04W 76/40; H04W 48/02; H04W 84/04

(52) U.S. Cl. CPC H04W 76/40; H04W 48/02; H04W 84/042

(57) ABSTRACT

Systems, methods, apparatuses, and computer program products for roaming of multicast MBS services. One method may include receiving, by a user equipment attached to a public land mobile network as an inbound roamer, a service announcement for a broadcast session or service class indicating whether inbound roamers are allowed to access the broadcast service or service class; determining, based on the service announcement, whether the user equipment is allowed to access a broadcast session or service class in the public land mobile network; and in response to determining that the user equipment is allowed to access a broadcast session or service class in the public land mobile network, transmitting, by the user equipment, a multicast/broadcast service interest indication associated with the broadcast session or service class upon completion of a radio resource request.

### CROSS-REFERENCE TO RELATED APPLICATIONS

This application claims priority to Great Britain Application No. 2312169.2, filed Aug. 9, 2023, the entire contents of which are incorporated herein by reference.

### TECHNICAL FIELD

Some example embodiments may generally relate to mobile or wireless telecommunication systems, such as 3^{rd} Generation Partnership Project (3GPP) Long Term Evolution (LTE), 5^{th} generation (5G) radio access technology (RAT), new radio (NR) access technology, 6^{th} generation (6G), and/or other communications systems. For example, certain example embodiments may relate to systems and/or methods for roaming of multicast MBS services.

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the radio access network (RAN) for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include receiving, by a user equipment attached to a PLMN as an inbound roamer, a service announcement for a broadcast session or service class indicating whether inbound roamers are allowed to access the broadcast service or service class. The method may further include determining, based on the service announcement, whether the user equipment is allowed to access a broadcast session or service class in the PLMN. The method may further include, in response to determining that the user equipment is allowed to access a broadcast session or service class in the PLMN, transmitting, by the user equipment, a multicast/broadcast service interest indication associated with the broadcast session or service class upon completion of a radio resource request.

In accordance with certain example embodiments, an apparatus may include means for receiving, when the apparatus is attached to a PLMN as an inbound roamer, a service announcement for a broadcast session or service class indicating whether inbound roamers are allowed to access the broadcast service or service class. The apparatus may further include means for determining, based on the service announcement, whether the apparatus is allowed to access a broadcast session or service class in the PLMN. The apparatus may further include means for, in response to determining that the apparatus is allowed to access a broadcast session or service class in the PLMN, transmitting a multicast/broadcast service interest indication associated with the broadcast session or service class upon completion of a radio resource request.

In accordance with various example embodiments, a non-transitory computer readable medium may include program instructions that, when executed by an apparatus, cause the apparatus to perform at least a method. The method may include receiving, when the apparatus is attached to a PLMN as an inbound roamer, a service announcement for a broadcast session or service class indicating whether inbound roamers are allowed to access the broadcast service or service class. The method may further include means for determining, based on the service announcement, whether the apparatus is allowed to access a broadcast session or service class in the PLMN. The method may further include, in response to determining that the apparatus is allowed to access a broadcast session or service class in the PLMN, transmitting a multicast/broadcast service interest indication associated with the broadcast session or service class upon completion of a radio resource request.

In accordance with some example embodiments, a computer program product may perform a method. The method may include receiving, when the apparatus is attached to a PLMN as an inbound roamer, a service announcement for a broadcast session or service class indicating whether inbound roamers are allowed to access the broadcast service or service class. The method may further include means for determining, based on the service announcement, whether the apparatus is allowed to access a broadcast session or service class in the PLMN. The method may further include, in response to determining that the apparatus is allowed to access a broadcast session or service class in the PLMN, transmitting a multicast/broadcast service interest indication associated with the broadcast session or service class upon completion of a radio resource request.

In accordance with certain example embodiments, an apparatus may include at least one processor and at least one memory storing instructions that, when executed by the at least one processor, cause the apparatus at least to receive, when the apparatus is attached to a PLMN as an inbound roamer, a service announcement for a broadcast session or service class indicating whether inbound roamers are allowed to access the broadcast service or service class. The at least one memory and instructions, when executed by the at least one processor, may further cause the apparatus at least to determine, based on the service announcement, whether the apparatus is allowed to access a broadcast session or service class in the PLMN. The at least one memory and instructions, when executed by the at least one processor, may further cause the apparatus at least to, in response to determining that the apparatus is allowed to access a broadcast session or service class in the PLMN, transmit a multicast/broadcast service interest indication associated with the broadcast session or service class upon completion of a radio resource request.

In accordance with various example embodiments, an apparatus may include receiving circuitry configured to perform receiving, when the apparatus is attached to a PLMN as an inbound roamer, a service announcement for a broadcast session or service class indicating whether inbound roamers are allowed to access the broadcast service or service class. The apparatus may further include determining circuitry configured to perform determining, based on the service announcement, whether the apparatus is allowed to access a broadcast session or service class in the PLMN. The apparatus may further include transmitting circuitry configured to perform, in response to determining that the apparatus is allowed to access a broadcast session or service class in the PLMN, transmit a multicast/broadcast service interest indication associated with the broadcast session or service class upon completion of a radio resource request.

In accordance with some example embodiments, a method may include determining, by a user equipment roaming in a visited PLMN, whether to transmit a multicast/broadcast service interest indication associated with a particular broadcast service class upon a radio resource request completed based on a configuration.

In accordance with certain example embodiments, an apparatus may include means for determining, when the apparatus is roaming in a visited PLMN, whether to transmit a multicast/broadcast service interest indication associated with a particular broadcast service class upon a radio resource request completed based on a configuration.

In accordance with various example embodiments, a non-transitory computer readable medium may include program instructions that, when executed by an apparatus, cause the apparatus to perform at least a method. The method may include determining, when the apparatus is roaming in a visited PLMN, whether to transmit a multicast/broadcast service interest indication associated with a particular broadcast service class upon a radio resource request completed based on a configuration.

In accordance with some example embodiments, a computer program product may perform a method. The method may include determining, when the apparatus is roaming in a visited PLMN, whether to transmit a multicast/broadcast service interest indication associated with a particular broadcast service class upon a radio resource request completed based on a configuration.

In accordance with certain example embodiments, an apparatus may include at least one processor and at least one memory storing instructions that, when executed by the at least one processor, cause the apparatus at least to determine, when the apparatus is roaming in a visited PLMN, whether to transmit a multicast/broadcast service interest indication associated with a particular broadcast service class upon a radio resource request completed based on a configuration.

In accordance with various example embodiments, an apparatus may include determining circuitry configured to perform determining, when the apparatus is roaming in a visited PLMN, whether to transmit a multicast/broadcast service interest indication associated with a particular broadcast service class upon a radio resource request completed based on a configuration.

In accordance with some example embodiments, a method may include transmitting, by a user equipment, a home PLMN or an inbound roamer indication in a radio resource control message.

In accordance with certain example embodiments, an apparatus may include means for transmitting a home PLMN or an inbound roamer indication in a radio resource control message.

In accordance with various example embodiments, a non-transitory computer readable medium may include program instructions that, when executed by an apparatus, cause the apparatus to perform at least a method. The method may include transmitting a home PLMN or an inbound roamer indication in a radio resource control message.

In accordance with some example embodiments, a computer program product may perform a method. The method may include transmitting a home PLMN or an inbound roamer indication in a radio resource control message.

In accordance with certain example embodiments, an apparatus may include at least one processor and at least one memory storing instructions that, when executed by the at least one processor, cause the apparatus at least to transmit a home PLMN or an inbound roamer indication in a radio resource control message.

In accordance with various example embodiments, an apparatus may include transmitting circuitry configured to perform transmitting a home PLMN or an inbound roamer indication in a radio resource control message.

In accordance with some example embodiments, a method may include determining, by a first network entity, whether a broadcast session or service class is accessible by inbound roamers. The method may further include, in response to determining that a broadcast session or service class is accessible by inbound roamers, transmitting, by the first network entity, a service announcement for a broadcast session or service class indicating whether inbound roamers are allowed to access the broadcast service or service class.

In accordance with certain example embodiments, an apparatus may include means for determining whether a broadcast session or service class is accessible by inbound roamers. The apparatus may further include means for, in response to determining that a broadcast session or service class is accessible by inbound roamers, transmitting a service announcement for a broadcast session or service class indicating whether inbound roamers are allowed to access the broadcast service or service class.

In accordance with various example embodiments, a non-transitory computer readable medium may include program instructions that, when executed by an apparatus, cause the apparatus to perform at least a method. The method may include determining whether a broadcast session or service class is accessible by inbound roamers. The method may further include, in response to determining that a broadcast session or service class is accessible by inbound roamers, transmitting a service announcement for a broadcast session or service class indicating whether inbound roamers are allowed to access the broadcast service or service class.

In accordance with some example embodiments, a computer program product may perform a method. The method may include determining whether a broadcast session or service class is accessible by inbound roamers. The method may further include, in response to determining that a broadcast session or service class is accessible by inbound roamers, transmitting a service announcement for a broadcast session or service class indicating whether inbound roamers are allowed to access the broadcast service or service class.

In accordance with certain example embodiments, an apparatus may include at least one processor and at least one memory storing instructions that, when executed by the at least one processor, cause the apparatus at least to determine whether a broadcast session or service class is accessible by inbound roamers. The at least one memory and instructions, when executed by the at least one processor, may further cause the apparatus at least to, in response to determining that a broadcast session or service class is accessible by inbound roamers, transmit a service announcement for a broadcast session or service class indicating whether inbound roamers are allowed to access the broadcast service or service class.

In accordance with various example embodiments, an apparatus may include determining circuitry configured to perform determining whether a broadcast session or service class is accessible by inbound roamers. The apparatus may further include transmitting circuitry configured to perform, in response to determining that a broadcast session or service class is accessible by inbound roamers, transmit a service announcement for a broadcast session or service class indicating whether inbound roamers are allowed to access the broadcast service or service class.

In accordance with some example embodiments, a method may include receiving, by a first network entity, a request for the establishment of a broadcast session or service from a second network entity. The method may further include determining whether inbound roamers are allowed to access the broadcast session or service. The method may further include transmitting a response to the request indicating whether inbound roamers are allowed to access the broadcast session or service.

In accordance with certain example embodiments, an apparatus may include means for receiving a request for the establishment of a broadcast session or service from a network entity. The apparatus may further include means for determining whether inbound roamers are allowed to access the broadcast session or service. The apparatus may further include means for transmitting a response to the request indicating whether inbound roamers are allowed to access the broadcast session or service.

In accordance with various example embodiments, a non-transitory computer readable medium may include program instructions that, when executed by an apparatus, cause the apparatus to perform at least a method. The method may include receiving a request for the establishment of a broadcast session or service from a network entity. The method may further include determining whether inbound roamers are allowed to access the broadcast session or service. The method may further include transmitting a response to the request indicating whether inbound roamers are allowed to access the broadcast session or service.

In accordance with some example embodiments, a computer program product may perform a method. The method may include receiving a request for the establishment of a broadcast session or service from a network entity. The method may further include determining whether inbound roamers are allowed to access the broadcast session or service. The method may further include transmitting a response to the request indicating whether inbound roamers are allowed to access the broadcast session or service.

In accordance with certain example embodiments, an apparatus may include at least one processor and at least one memory storing instructions that, when executed by the at least one processor, cause the apparatus at least to receive a request for the establishment of a broadcast session or service from a network entity. The at least one memory and instructions, when executed by the at least one processor, may further cause the apparatus at least to determine whether inbound roamers are allowed to access the broadcast session or service. The at least one memory and instructions, when executed by the at least one processor, may further cause the apparatus at least to transmit a response to the request indicating whether inbound roamers are allowed to access the broadcast session or service.

In accordance with various example embodiments, an apparatus may include receiving circuitry configured to perform receiving a request for the establishment of a broadcast session or service from a network entity. The apparatus may further include determining circuitry configured to perform determining whether inbound roamers are allowed to access the broadcast session or service. The apparatus may further include transmitting circuitry configured to perform transmit a response to the request indicating whether inbound roamers are allowed to access the broadcast session or service.

In accordance with some example embodiments, a method may include receiving, by a first network entity, a request from a second network entity to establish a broadcast session or service. The method may further include receiving, by the first network entity, a request from a user equipment for user service registration for the broadcast service. The method may further include determining, by the first network entity, whether the user equipment is an inbound roaming user equipment. The method may further include, in response to determining that the user equipment is an inbound roaming user equipment, determining whether the user equipment is allowed to access the broadcast session or service. The method may further include, based upon the determination of whether the user equipment is allowed to access the broadcast session or service, accepting the request from the user equipment, and providing a multicast broadcast service key to the user equipment, or rejecting the request from the user equipment.

In accordance with certain example embodiments, an apparatus may include means for receiving a request from a network entity to establish a broadcast session or service. The apparatus may further include means for receiving a request from a user equipment for user service registration for the broadcast service. The apparatus may further include means for determining whether the user equipment is an inbound roaming user equipment. The apparatus may further include means for, in response to determining that the user equipment is an inbound roaming user equipment, determining whether the user equipment is allowed to access the broadcast session or service. The apparatus may further include means for, based upon the determination of whether the user equipment is allowed to access the broadcast session or service, accepting the request from the user equipment, and providing a multicast broadcast service key to the user equipment, or rejecting the request from the user equipment.

In accordance with various example embodiments, a non-transitory computer readable medium may include program instructions that, when executed by an apparatus, cause the apparatus to perform at least a method. The method may include receiving a request from a network entity to establish a broadcast session or service. The method may further include receiving a request from a user equipment for user service registration for the broadcast service. The method may further include determining whether the user equipment is an inbound roaming user equipment. The method may further include, in response to determining that the user equipment is an inbound roaming user equipment, determining whether the user equipment is allowed to access the broadcast session or service. The method may further include, based upon the determination of whether the user equipment is allowed to access the broadcast session or service, accepting the request from the user equipment, and providing a multicast broadcast service key to the user equipment, or rejecting the request from the user equipment.

In accordance with some example embodiments, a computer program product may perform a method. The method may include receiving a request from a network entity to establish a broadcast session or service. The method may further include receiving a request from a user equipment for user service registration for the broadcast service. The method may further include determining whether the user equipment is an inbound roaming user equipment. The method may further include, in response to determining that the user equipment is an inbound roaming user equipment, determining whether the user equipment is allowed to access the broadcast session or service. The method may further include, based upon the determination of whether the user equipment is allowed to access the broadcast session or service, accepting the request from the user equipment, and providing a multicast broadcast service key to the user equipment, or rejecting the request from the user equipment.

In accordance with certain example embodiments, an apparatus may include at least one processor and at least one memory storing instructions that, when executed by the at least one processor, cause the apparatus at least to receive a request from a network entity to establish a broadcast session or service. The at least one memory and instructions, when executed by the at least one processor, may further cause the apparatus at least to receive a request from a user equipment for user service registration for the broadcast service. The at least one memory and instructions, when executed by the at least one processor, may further cause the apparatus at least to determine whether the user equipment is an inbound roaming user equipment. The at least one memory and instructions, when executed by the at least one processor, may further cause the apparatus at least to, in response to determining that the user equipment is an inbound roaming user equipment, determine whether the user equipment is allowed to access the broadcast session or service. The at least one memory and instructions, when executed by the at least one processor, may further cause the apparatus at least to, based upon the determination of whether the user equipment is allowed to access the broadcast session or service, accept the request from the user equipment, and provide a multicast broadcast service key to the user equipment, or reject the request from the user equipment.

In accordance with various example embodiments, an apparatus may include receiving circuitry configured to perform receive a request from a network entity to establish a broadcast session or service. The apparatus may further include receiving circuitry configured to perform receive a request from a user equipment for user service registration for the broadcast service. The apparatus may further include determining circuitry configured to perform determine whether the user equipment is an inbound roaming user equipment. The apparatus may further include determining circuitry configured to perform, in response to determining that the user equipment is an inbound roaming user equipment, determining whether the user equipment is allowed to access the broadcast session or service. The apparatus may further include processing circuitry configured to perform, based upon the determination of whether the user equipment is allowed to access the broadcast session or service, accepting the request from the user equipment, and providing a multicast broadcast service key to the user equipment, or rejecting the request from the user equipment.

In accordance with some example embodiments, a method may include receiving, by a first network entity, a broadcast session or service start comprising roaming restriction information. The method may further include storing, by the first network entity, the roaming restriction information for the broadcast session or service. The method may further include transmitting, by the first network entity, a next generation application protocol broadcast session setup request message to a second network entity. The method may further include receiving, by the first network entity, a next generation application protocol user equipment authorization request from the second network entity comprising an identifier of the broadcast session or service, and an identifier of the user equipment. The method may further include determining, by the first network entity, based on roaming restriction information for the broadcast session or service whether the user equipment is authorized to receive the broadcast session or service. The method may further include transmitting, by the first network entity, a next generation application protocol user equipment authorization reply message to the second network entity indicating whether the user equipment is authorized to receive the broadcast session or service.

In accordance with certain example embodiments, an apparatus may include means for receiving a broadcast session or service start comprising roaming restriction information. The apparatus may further include means for storing the roaming restriction information for the broadcast session or service. The apparatus may further include means for transmitting a next generation application protocol broadcast session setup request message to a network entity. The apparatus may further include means for receiving a next generation application protocol user equipment authorization request from the network entity comprising an identifier of the broadcast session or service, and an identifier of the user equipment. The apparatus may further include means for determining based on roaming restriction information for the broadcast session or service whether the user equipment is authorized to receive the broadcast session or service. The apparatus may further include means for transmitting a next generation application protocol user equipment authorization reply message to the network entity indicating whether the user equipment is authorized to receive the broadcast session or service.

In accordance with various example embodiments, a non-transitory computer readable medium may include program instructions that, when executed by an apparatus, cause the apparatus to perform at least a method. The method may include receiving a broadcast session or service start comprising roaming restriction information. The method may further include storing the roaming restriction information for the broadcast session or service. The method may further include transmitting a next generation application protocol broadcast session setup request message to a network entity. The method may further include receiving a next generation application protocol user equipment authorization request from the network entity comprising an identifier of the broadcast session or service, and an identifier of the user equipment. The method may further include determining based on roaming restriction information for the broadcast session or service whether the user equipment is authorized to receive the broadcast session or service. The method may further include transmitting a next generation application protocol user equipment authorization reply message to the network entity indicating whether the user equipment is authorized to receive the broadcast session or service.

In accordance with some example embodiments, a computer program product may perform a method. The method may include receiving a broadcast session or service start comprising roaming restriction information. The method may further include storing the roaming restriction information for the broadcast session or service. The method may further include transmitting a next generation application protocol broadcast session setup request message to a network entity. The method may further include receiving a next generation application protocol user equipment authorization request from the network entity comprising an identifier of the broadcast session or service, and an identifier of the user equipment. The method may further include determining based on roaming restriction information for the broadcast session or service whether the user equipment is authorized to receive the broadcast session or service. The method may further include transmitting a next generation application protocol user equipment authorization reply message to the network entity indicating whether the user equipment is authorized to receive the broadcast session or service.

In accordance with certain example embodiments, an apparatus may include at least one processor and at least one memory storing instructions that, when executed by the at least one processor, cause the apparatus at least to receive a broadcast session or service start comprising roaming restriction information. The at least one memory and instructions, when executed by the at least one processor, may further cause the apparatus at least to store the roaming restriction information for the broadcast session or service. The at least one memory and instructions, when executed by the at least one processor, may further cause the apparatus at least to transmit a next generation application protocol broadcast session setup request message to a network entity. The at least one memory and instructions, when executed by the at least one processor, may further cause the apparatus at least to receive a next generation application protocol user equipment authorization request from the network entity comprising an identifier of the broadcast session or service, and an identifier of the user equipment. The at least one memory and instructions, when executed by the at least one processor, may further cause the apparatus at least to determine based on roaming restriction information for the broadcast session or service whether the user equipment is authorized to receive the broadcast session or service. The at least one memory and instructions, when executed by the at least one processor, may further cause the apparatus at least to transmit a next generation application protocol user equipment authorization reply message to the network entity indicating whether the user equipment is authorized to receive the broadcast session or service.

In accordance with various example embodiments, an apparatus may include receiving circuitry configured to perform receiving a broadcast session or service start comprising roaming restriction information. The apparatus may further include storing circuitry configured to perform store the roaming restriction information for the broadcast session or service. The apparatus may further include transmitting circuitry configured to perform transmit a next generation application protocol broadcast session setup request message to a network entity. The apparatus may further include receiving circuitry configured to perform receiving a next generation application protocol user equipment authorization request from the network entity comprising an identifier of the broadcast session or service, and an identifier of the user equipment. The apparatus may further include determining circuitry configured to perform determine based on roaming restriction information for the broadcast session or service whether the user equipment is authorized to receive the broadcast session or service. The apparatus may further include transmitting circuitry configured to perform transmitting a next generation application protocol user equipment authorization reply message to the network entity indicating whether the user equipment is authorized to receive the broadcast session or service.

In accordance with some example embodiments, a method may include receiving, by a first network entity, an interest indication for a broadcast session or service for a user equipment. The method may further include sending, by the first network entity, a next generation application protocol user equipment authorization request comprising an identifier of the broadcast session or service, and an identifier of the user equipment to a second network entity. The method may further include receiving, by the first network entity, a next generation application protocol user equipment authorization reply message from the second network entity comprising an indication of whether the user equipment is authorized to receive the broadcast session or service. The method may further include, based upon the authorization indication, determining whether to take into consideration the user equipment interest indication for the broadcast session or service.

In accordance with certain example embodiments, an apparatus may include means for receiving an interest indication for a broadcast session or service for a user equipment. The apparatus may further include means for sending a next generation application protocol user equipment authorization request comprising an identifier of the broadcast session or service, and an identifier of the user equipment to a network entity. The apparatus may further include means for receiving a next generation application protocol user equipment authorization reply message from the network entity comprising an indication of whether the user equipment is authorized to receive the broadcast session or service. The apparatus may further include means for, based upon the authorization indication, determining whether to take into consideration the user equipment interest indication for the broadcast session or service.

In accordance with various example embodiments, a non-transitory computer readable medium may include program instructions that, when executed by an apparatus, cause the apparatus to perform at least a method. The method may include receiving an interest indication for a broadcast session or service for a user equipment. The method may further include sending a next generation application protocol user equipment authorization request comprising an identifier of the broadcast session or service, and an identifier of the user equipment to a network entity. The method may further include receiving a next generation application protocol user equipment authorization reply message from the network entity comprising an indication of whether the user equipment is authorized to receive the broadcast session or service. The method may further include, based upon the authorization indication, determining whether to take into consideration the user equipment interest indication for the broadcast session or service.

In accordance with some example embodiments, a computer program product may perform a method. The method may include receiving an interest indication for a broadcast session or service for a user equipment. The method may further include sending a next generation application protocol user equipment authorization request comprising an identifier of the broadcast session or service, and an identifier of the user equipment to a network entity. The method may further include receiving a next generation application protocol user equipment authorization reply message from the network entity comprising an indication of whether the user equipment is authorized to receive the broadcast session or service. The method may further include, based upon the authorization indication, determining whether to take into consideration the user equipment interest indication for the broadcast session or service.

In accordance with certain example embodiments, an apparatus may include at least one processor and at least one memory storing instructions that, when executed by the at least one processor, cause the apparatus at least to receive an interest indication for a broadcast session or service for a user equipment. The at least one memory and instructions, when executed by the at least one processor, may further cause the apparatus at least to send a next generation application protocol user equipment authorization request comprising an identifier of the broadcast session or service, and an identifier of the user equipment to a network entity. The at least one memory and instructions, when executed by the at least one processor, may further cause the apparatus at least to receive a next generation application protocol user equipment authorization reply message from the network entity comprising an indication of whether the user equipment is authorized to receive the broadcast session or service. The at least one memory and instructions, when executed by the at least one processor, may further cause the apparatus at least to, based upon the authorization indication, determine whether to take into consideration the user equipment interest indication for the broadcast session or service.

In accordance with various example embodiments, an apparatus may include receiving circuitry configured to perform receive an interest indication for a broadcast session or service for a user equipment. The apparatus may further include sending circuitry configured to perform send a next generation application protocol user equipment authorization request comprising an identifier of the broadcast session or service, and an identifier of the user equipment to a network entity. The apparatus may further include receiving circuitry configured to perform receiving a next generation application protocol user equipment authorization reply message from the network entity comprising an indication of whether the user equipment is authorized to receive the broadcast session or service. The apparatus may further include determining circuitry configured to perform, based upon the authorization indication, determine whether to take into consideration the user equipment interest indication for the broadcast session or service.

In accordance with some example embodiments, a method may include transmitting a handover required message for the user equipment comprising at least one of a home PLMN identifier, an inbound roamer indication, or a multicast/broadcast interest indication configured for the user equipment.

In accordance with certain example embodiments, an apparatus may include means for transmitting a handover required message for a user equipment comprising at least one of a home PLMN identifier, an inbound roamer indication, or a multicast/broadcast interest indication configured for the user equipment.

In accordance with various example embodiments, a non-transitory computer readable medium may include program instructions that, when executed by an apparatus, cause the apparatus to perform at least a method. The method may include transmitting a handover required message for a user equipment comprising at least one of a home PLMN identifier, an inbound roamer indication, or a multicast/broadcast interest indication configured for the user equipment.

In accordance with some example embodiments, a computer program product may perform a method. The method may include transmitting a handover required message for a user equipment comprising at least one of a home PLMN identifier, an inbound roamer indication, or a multicast/broadcast interest indication configured for the user equipment.

In accordance with certain example embodiments, an apparatus may include at least one processor and at least one memory storing instructions that, when executed by the at least one processor, cause the apparatus at least to transmit a handover required message for a user equipment comprising at least one of a home PLMN identifier, an inbound roamer indication, or a multicast/broadcast interest indication configured for the user equipment.

In accordance with various example embodiments, an apparatus may include transmitting circuitry configured to perform transmitting a handover required message for a user equipment comprising at least one of a home PLMN identifier, an inbound roamer indication, or a multicast/broadcast interest indication configured for the user equipment.

In accordance with some example embodiments, a method may include receiving, by a first network entity, a broadcast session start request for a broadcast session comprising roaming restriction information. The method may further include transmitting, by the first network entity, at least one next generation application protocol broadcast session setup request message to a second network entity configured for a broadcast session comprising the roaming restriction information.

In accordance with certain example embodiments, an apparatus may include means for receiving a broadcast session start request for a broadcast session comprising roaming restriction information. The apparatus may further include means for transmitting at least one next generation application protocol broadcast session setup request message to a network entity configured for a broadcast session comprising the roaming restriction information.

In accordance with various example embodiments, a non-transitory computer readable medium may include program instructions that, when executed by an apparatus, cause the apparatus to perform at least a method. The method may include receiving a broadcast session start request for a broadcast session comprising roaming restriction information. The method may further include transmitting at least one next generation application protocol broadcast session setup request message to a network entity configured for a broadcast session comprising the roaming restriction information.

In accordance with some example embodiments, a computer program product may perform a method. The method may include receiving a broadcast session start request for a broadcast session comprising roaming restriction information. The method may further include transmitting at least one next generation application protocol broadcast session setup request message to a network entity configured for a broadcast session comprising the roaming restriction information.

In accordance with certain example embodiments, an apparatus may include at least one processor and at least one memory storing instructions that, when executed by the at least one processor, cause the apparatus at least to receive a broadcast session start request for a broadcast session comprising roaming restriction information. The at least one memory and instructions, when executed by the at least one processor, may further cause the apparatus at least to transmit at least one next generation application protocol broadcast session setup request message to a network entity configured for a broadcast session comprising the roaming restriction information.

In accordance with various example embodiments, an apparatus may include receiving circuitry configured to perform receiving a broadcast session start request for a broadcast session comprising roaming restriction information. The apparatus may further include transmitting circuitry configured to perform transmitting at least one next generation application protocol broadcast session setup request message to a network entity configured for a broadcast session comprising the roaming restriction information.

In accordance with some example embodiments, a method may include receiving, by a network entity, a next generation application protocol broadcast session setup request message for a broadcast session from a core network entity comprising roaming restriction information. The method may further include storing the roaming restriction information for the broadcast session. The method may further include receiving, by the network entity, from the core network entity, at least one of a next generation application protocol initiation context setup request for the user equipment comprising a home PLMN identifier and a handover request message for a user equipment comprising a home PLMN identifier. The method may further include receiving, by the network entity, an interest indication for the user equipment for the broadcast session. The method may further include determining, by the network entity, based on the stored roaming restriction information and the home PLMN identifier of the user equipment, whether to take into consideration the user equipment interest indication for the broadcast session or service.

In accordance with certain example embodiments, an apparatus may include means for receiving a next generation application protocol broadcast session setup request message for a broadcast session from a core network entity comprising roaming restriction information. The apparatus may further include means for storing the roaming restriction information for the broadcast session. The apparatus may further include means for receiving, from the core network entity, at least one of a next generation application protocol initiation context setup request for a user equipment comprising a home PLMN identifier and a handover request message for the user equipment comprising a home PLMN identifier. The apparatus may further include means for receiving an interest indication for the user equipment for the broadcast session. The apparatus may further include means for determining, based on the stored roaming restriction information and the home PLMN identifier of the user equipment, whether to take into consideration the user equipment interest indication for the broadcast session or service.

In accordance with various example embodiments, a non-transitory computer readable medium may include program instructions that, when executed by an apparatus, cause the apparatus to perform at least a method. The method may include receiving a next generation application protocol broadcast session setup request message for a broadcast session from a core network entity comprising roaming restriction information. The method may further include storing the roaming restriction information for the broadcast session. The method may further include receiving, from the core network entity, at least one of a next generation application protocol initiation context setup request for a user equipment comprising a home PLMN identifier and a handover request message for the user equipment comprising a home PLMN identifier. The method may further include receiving an interest indication for the user equipment for the broadcast session. The method may further include determining, based on the stored roaming restriction information and the home PLMN identifier of the user equipment, whether to take into consideration the user equipment interest indication for the broadcast session or service.

In accordance with some example embodiments, a computer program product may perform a method. The method may include receiving a next generation application protocol broadcast session setup request message for a broadcast session from a core network entity comprising roaming restriction information. The method may further include storing the roaming restriction information for the broadcast session. The method may further include receiving, from the core network entity, at least one of a next generation application protocol initiation context setup request for a user equipment comprising a home PLMN identifier and a handover request message for the user equipment comprising a home PLMN identifier. The method may further include receiving an interest indication for the user equipment for the broadcast session. The method may further include determining, based on the stored roaming restriction information and the home PLMN identifier of the user equipment, whether to take into consideration the user equipment interest indication for the broadcast session or service.

In accordance with certain example embodiments, an apparatus may include at least one processor and at least one memory storing instructions that, when executed by the at least one processor, cause the apparatus at least to receive a next generation application protocol broadcast session setup request message for a broadcast session from a core network entity comprising roaming restriction information. The at least one memory and instructions, when executed by the at least one processor, may further cause the apparatus at least to store the roaming restriction information for the broadcast session. The at least one memory and instructions, when executed by the at least one processor, may further cause the apparatus at least to receive, from the core network entity, at least one of a next generation application protocol initiation context setup request for a user equipment comprising a home PLMN identifier and a handover request message for the user equipment comprising a home PLMN identifier. The at least one memory and instructions, when executed by the at least one processor, may further cause the apparatus at least to receive an interest indication for the user equipment for the broadcast session. The at least one memory and instructions, when executed by the at least one processor, may further cause the apparatus at least to determine, based on the stored roaming restriction information and the home PLMN identifier of the user equipment, whether to take into consideration the user equipment interest indication for the broadcast session or service.

In accordance with various example embodiments, an apparatus may include receiving circuitry configured to perform receiving a next generation application protocol broadcast session setup request message for a broadcast session from a core network entity comprising roaming restriction information. The apparatus may further include storing circuitry configured to perform storing the roaming restriction information for the broadcast session. The apparatus may further include receiving circuitry configured to perform receiving, from the core network entity, at least one of a next generation application protocol initiation context setup request for a user equipment comprising a home PLMN identifier and a handover request message for the user equipment comprising a home PLMN identifier. The apparatus may further include receiving circuitry configured to perform receiving an interest indication for the user equipment for the broadcast session. The apparatus may further include determining circuitry configured to perform determining, based on the stored roaming restriction information and the home PLMN identifier of the user equipment, whether to take into consideration the user equipment interest indication for the broadcast session or service.

In accordance with some example embodiments, a method may include sending a handover required message for a user equipment comprising a home PLMN identifier.

In accordance with certain example embodiments, an apparatus may include means for sending a handover required message for a user equipment comprising a home PLMN identifier.

In accordance with various example embodiments, a non-transitory computer readable medium may include program instructions that, when executed by an apparatus, cause the apparatus to perform at least a method. The method may include sending a handover required message for a user equipment comprising a home PLMN identifier.

In accordance with some example embodiments, a computer program product may perform a method. The method may include sending a handover required message for a user equipment comprising a home PLMN identifier.

In accordance with certain example embodiments, an apparatus may include at least one processor and at least one memory storing instructions that, when executed by the at least one processor, cause the apparatus at least to send a handover required message for a user equipment comprising a home PLMN identifier.

In accordance with various example embodiments, an apparatus may include sending circuitry configured to perform sending a handover required message for a user equipment comprising a home PLMN identifier.

### BRIEF DESCRIPTION OF THE DRAWINGS

For a proper understanding of example embodiments, reference should be made to the accompanying drawings, wherein:

FIG. 1 illustrates an example of a signaling diagram when a service announcement indicates whether in-bound roamers are allowed to access the broadcast MBS service or service class according to certain example embodiments;

FIG. 2 illustrates an example of a signaling diagram wherein inbound restrictions information is sent by an MB-SMF and stored in an AMF according to some example embodiments;

FIG. 3 illustrates an example of a signaling diagram relating to VPLMN inbound restrictions check failures at an AMF according to various example embodiments;

FIG. 4 illustrates an example of a signaling diagram relating to VPLMN inbound restrictions check successes at an AMF according to certain example embodiments;

FIG. 5 illustrates an example of a signaling diagram relating to inbound restrictions information sent by an MB-SMF and stored in an NG-RAN node according to certain example embodiments;

FIG. 6 illustrates an example of a signaling diagram relating to VPLMN inbound restrictions checks in a NG-RAN node (failure/success) according to certain example embodiments;

FIG. 7 illustrates an example of a signaling diagram relating to inbound broadcast service restriction checks after inter-PLMN handovers according to some example embodiments;

FIG. 8 illustrates an example of a signaling diagram relating to HPLMN outbound broadcast service restrictions check failures according to various example embodiments;

FIG. 9 illustrates an example of a signaling diagram relating to HPLMN outbound broadcast service restrictions check successes according to certain example embodiments;

FIG. 10 illustrates an example of a flow diagram of a method according to certain example embodiments;

FIG. 11 illustrates an example of a flow diagram of a method according to some example embodiments;

FIG. 12 illustrates an example of a flow diagram of a method according to various example embodiments;

FIG. 13 illustrates an example of a flow diagram of a method according to certain example embodiments;

FIG. 14 illustrates an example of a flow diagram of a method according to some example embodiments;

FIG. 15 illustrates an example of a flow diagram of a method according to various example embodiments;

FIG. 16 illustrates an example of a flow diagram of a method according to certain example embodiments;

FIG. 17 illustrates an example of a flow diagram of a method according to some example embodiments;

FIG. 18 illustrates an example of a flow diagram of a method according to various example embodiments;

FIG. 19 illustrates an example of a flow diagram of a method according to certain example embodiments;

FIG. 20 illustrates an example of a flow diagram of a method according to some example embodiments;

FIG. 21 illustrates an example of a flow diagram of a method according to various example embodiments;

FIG. 22 illustrates an example of various network devices according to some example embodiments; and

FIG. 23 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for roaming of multicast MBS services is not intended to limit the scope of certain example embodiments, but is instead representative of selected example embodiments.

In general, MBS services may enable communication to a plurality of user equipment. However, roaming is currently unsupported for multicast MBS services.

There is a need for VPLMN and/or V-AF to allow or disallow multicast MBS services to inbound roamers, such as for services provided locally in the VPLMN (e.g., local tourist information) and/or in the VPLMN from a same service class as subscribed by the user in the HPLMN (e.g., weather forecast). Furthermore, there is a need for HPLMNs to allow or disallow multicast MBS services to outbound roamers, such as for services provided in the VPLMN (e.g., from a same service class as subscribed by the user in the HPLMN such as weather forecast).

Certain example embodiments described herein may have various benefits and/or advantages to overcome the disadvantages described above. For example, certain example embodiments may enable the HPLMN operator to allow or disallow all or specific multicast MBS services when the UE is (outbound) roaming in a VPLMN, and may enable the VPLMN operator to allow or disallow all or specific multicast MBS services to UEs (in-bound) roaming in the VPLMN. Furthermore, some example embodiments may enable the V-AF to allow or disallow a specific multicast MBS service to UEs (in-bound) roaming in the VPLMN. In addition, multicast MBS services may be identified by an MBS service class, thus allowing different TMGIs or source specific multicast address to be used in HPLMN and each VPLMN. Various example embodiments may also conserve signaling by preventing the UE to unnecessarily try to join a multicast MBS session and then get rejected due to not being authorized for roaming. Thus, certain example embodiments discussed below are directed to improvements in computer-related technology.

A VPLMN, or an AF attached to the VPLMN, may be configured with authorization information indicating whether a broadcast MBS service provided by the VPLMN is allowed to be accessed by inbound roamers of all or of certain HPLMNs with which the VPLMN operator has roaming/SLA agreements. MBS service authorization that is configured in the VPLMN may be associated with an MBS session ID (TMGI or source specific IP multicast address), with an MBS service class (e.g., weather forecast), and/or may apply to all MBS services provided by the VPLMN that are not restricted to specific users. The VPLMN MBS service authorization information may be configured in an MB-SMF of the VPLMN, or in a database of the VPLMN.

In certain example embodiments, a service announcement of a broadcast service may only be provided by the AF attached to the VPLMNs to UEs which are entitled to receive the MBS service in the VPLMN according to the authorization information. Alternatively, the AF may indicate in the service announcement whether inbound roamers are allowed to access the broadcast service. Additionally, the service announcement may include a list of PLMNs corresponding to the HPLMNs of those inbound roamers which are allowed/disallowed to access the broadcast service and/or an MBS service class. The UE may be configured with information about MBS service classes it can access when roaming, possibly related to specific VPLMNs.

The AF attached to the VPLMN may be configured with MBS service class and/or authorization information and/or it may obtain the authorization from the VPLMN when requesting the establishment of an MBS broadcast session. For example, during the establishment of a broadcast MBS session, the V-AF may indicate to the NEF/MB-SMF whether the broadcast MBS session is open to (i.e., allowed to be accessed by) inbound roamers from all or specific HPLMNs and/or it may provide the MBS service class of the broadcast MBS service. Alternatively, the NEF may be configured with a mapping of AF IDs or MBS session IDs to service classes, and may add the service class when forwarding an MBS session establishment request to the MB-SMF. In certain example embodiments, the mapping of MBS session IDs to service classes is configured in a database of the VPLMN and looked up by NEF, MB-SMF in the VPLMN.

The NEF or MB-SMF may provide the service class in the response to the MBS session establishment request to the NEF/AF. The NEF or MB-SMF may also indicate in the response to the establishment of an MBS session whether in-bound roamers are allowed to access the broadcast MBS service, possibly with the PLMNs of allowed (or disallowed) in-bound roamers. If the AF encrypts the broadcast data it provides, it may only provide keys enabling the description to roaming users which are authorized to use the service.

Some example embodiments may relate to broadcast inbound restrictions checks in an AMF. The broadcast MBS service authorization configured in VPLMN may be associated with an MBS Session ID (TMGI or source specific IP multicast address) or with an MBS service class (e.g., weather forecast).

For example, various example embodiments may include broadcast inbound-restrictions information sent at a broadcast session start and stored in an AMF. The VPLMN may allow broadcast MBS services to in-bound roamers. Specifically, when the broadcast session of a certain MBS service class is started in the VPLMN, the MB-SMF may send to the AMF the broadcast session start message and indicate whether the broadcast session is allowed to in-bound roamers, is allowed to inbound roamers of an indicated list (e.g., whitelist) of PLMNs, and/or is allowed to inbound roamers except an indicated list (e.g., blacklist) of PLMNs. The AMF may then store the above information for further checking.

As an example, VPLMN broadcast inbound restrictions may be checked at the AMF. Specifically, whenever a UE gets RRC connected, the AMF may send to the NG-RAN node the HPLMN ID corresponding to the Home PLMN of the UE or an indication that the UE is an inbound roamer. The NG-RAN node may store this HPLMN ID or inbound roamer indicator. Alternatively, the NG-RAN node may receive the HPLMN ID or inbound roamer indication in the RRC setup complete message or any RRC message following the RRC setup complete message.

When the UE in RRC connected mode sends the mobility interest indication (MII) for a broadcast session, inbound restrictions authorizations may be checked for UEs which are inbound roamers. Specifically, the gNB may send an NGAP UE dedicated Authorization Request message to AMF. The AMF may then check if the broadcast service has no restriction for inbound roamers: if the service is restricted to all inbound roamers AMF sends an NG Authorization Failure message. Otherwise, the AMF may check if the broadcast service has restrictions for certain PLMNs and if the HPLMN of the UE corresponds to one these PLMNs in restriction. If yes, the AMF may send an NG Authorization Failure message. Otherwise, the AMF may send back an NG Authorization Response to the gNB. If the gNB receives NG Authorization Response message, it may steer the UE to suitable frequency to receive the interested broadcast service. If instead the gNB receives the NG Authorization Failure message, it may ignore the MII earlier received from the UE. The gNB may then optionally send to the UE over RRC a notification that the corresponding broadcast service is allowed/disallowed.

Various example embodiments may relate to broadcast inbound-restrictions checks at an NG-RAN node. For example, broadcast inbound-restrictions information may be sent at a broadcast session start and stored in a NG-RAN.

The VPLMN may allow broadcast MBS services to in-bound roamers. When the broadcast session of a certain MBS service class is started in the VPLMN, the MB-SMF sends to the AMF the Broadcast Session Start message and indicates to the AMF whether the broadcast session is allowed to in-bound roamers, is allowed to inbound roamers of an indicated list of PLMNs, and/or is allowed to inbound roamers except an indicated list of PLMNs. The AMF in-turns sends the NGAP Broadcast Session Setup Request message to involved NG-RAN nodes (e.g., gNBs) indicating to NG-RAN nodes whether the broadcast session is allowed to in-bound roamers, is allowed to inbound roamers of an indicated list of PLMNs, and/or is allowed to inbound roamers except an indicated list of PLMNs. The NG-RAN node may store the above information for further checking.

Some example embodiments may include broadcast inbound restrictions checks in the gNB. Whenever a UE gets RRC connected, the AMF may send to the NG-RAN node the HPLMN ID corresponding to the Home PLMN of the UE. The NG-RAN node stores this HPLMN ID. Alternatively, the NG-RAN node may receive the HPLMN ID in the RRC setup complete message or any RRC message following the RRC setup complete message. When the UE in RRC connected mode sends the MBS Interest Indication (MII) to the NG-RAN node for a broadcast session, inbound restrictions authorizations are checked in the NG-RAN node, wherein the NG-RAN node checks if the broadcast service has no restriction for inbound roamers: if the service is restricted to all inbound roamers NG-RAN considers the check as unsuccessful. Otherwise, the NG-RAN node checks if the broadcast service has restrictions for certain PLMNs and if the HPLMN of the UE (earlier received from the AMF when UE got RRC connected) corresponds to one these PLMNs in restriction. If yes, the NG-RAN node considers the check as unsuccessful. Otherwise, the NG-RAN node considers the check as successful. In case of successful check, the NG-RAN node may steer the UE to suitable frequency to receive the interested broadcast service. If instead the check is considered unsuccessful, the NG-RAN node ignores the MII received from the UE. The gNB may then optionally send to the UE over RRC a notification that the corresponding broadcast service is allowed/disallowed.

In certain example embodiments, broadcast inbound restrictions may be checked in case of inter-PLMN handover. In case of inter-PLMN handovers, the HPLMN ID of the UE may be transferred from source to target either from source AMF to target AMF: after being received by target AMF from source AMF, the HPLMN ID may be included in NGAP Handover Request message from target AMF to target gNB. Alternatively, this may be sent from source gNB to target gNB: the HPLMN ID may be included in the NGAP source to target transparent container or in the inter-node RRC container from source to target. At inter-system handover, the target gNB may already receive the MII from source gNB. Upon completion of an inter-PLMN handover, the target gNB may check if the UE is an inbound roamer and if it is, it triggers allowance checks for the broadcast services indicated through the received MII and using the received HPLMN ID of the UE. Specifically, in case of an AMF check, it may trigger the broadcast authorization request; alternatively, in case of an gNB check, it may check the allowance.

Various example embodiments may include broadcast outbound restrictions checks between a gNB and an AMF. When the UE in RRC connected mode sends the MII for a broadcast session, outbound restrictions authorization from H-PLMN are checked. Specifically, the gNB may send an NGAP UE dedicated Authorization Request message to an AMF, and the AMF may check from the UE's subscription received from the UDM if it forbids certain service class when UE is roaming and if the interested broadcast service belongs to this service class. If yes, it may send an NG Authorization Failure message. Alternatively, the AMF may check from the UE's subscription received from the UDM if it forbids certain service class when UE is roaming in specific PLMNs and if the interested broadcast service (received from MII) belongs to this service class and the VPLMN belongs to the list of specific PLMNs. If yes, it may send an NG Authorization Failure message. The AMF may check from the UE's subscription received from the UDM if it forbids certain list of TMGIs when UE is roaming and if the interested broadcast service belongs to this list of TMGIs. If yes, it may send an NG Authorization Failure message. The AMF may check from the UE's subscription received from the UDM if it forbids any combination of the above. If yes it sends an NG Authorization Failure message. Otherwise, the AMF may send back an NG Authorization Response to the gNB.

It is noted that any of the embodiments discussed herein may relate to an SNPN instead of an PLMN.

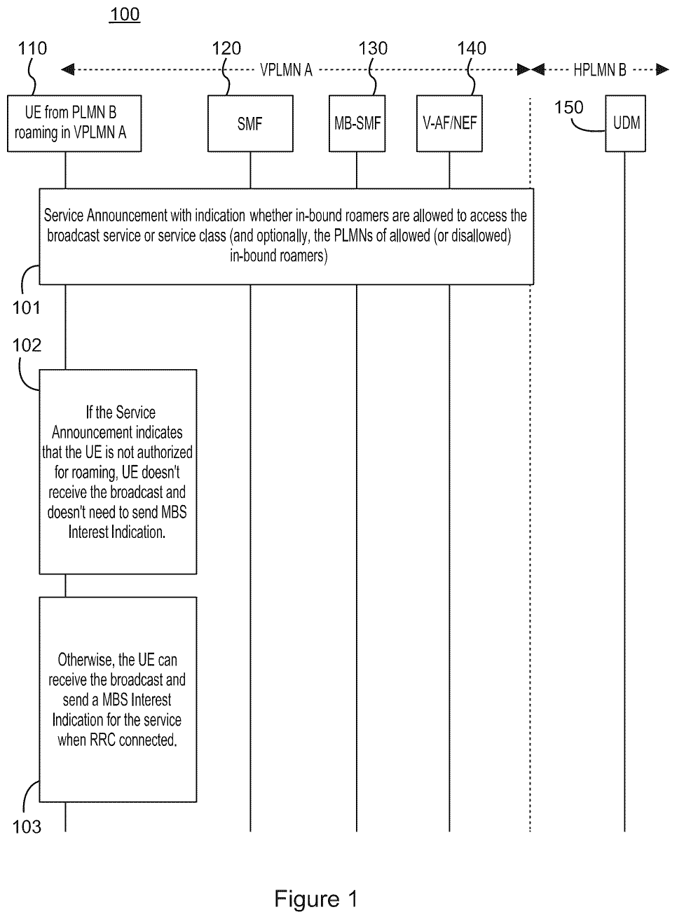

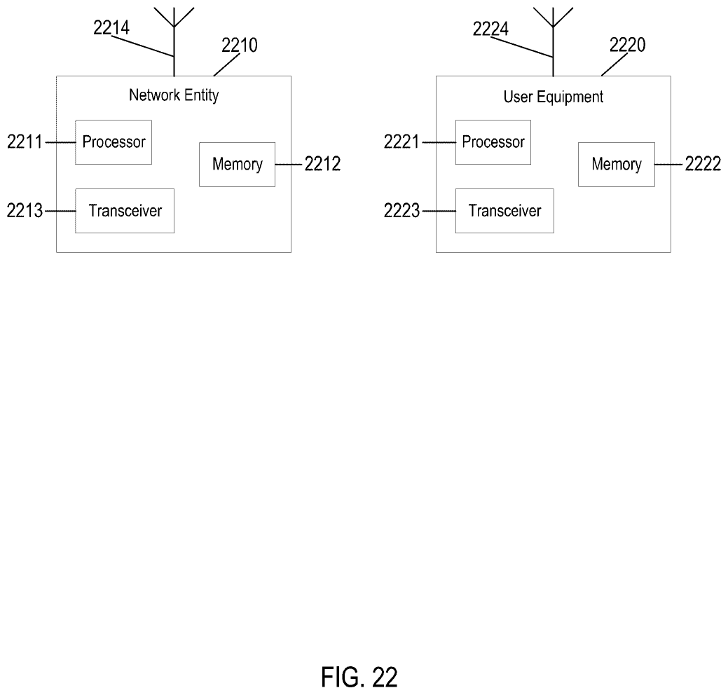

FIG. 1 illustrates an example of a signaling diagram 100 depicting when a service announcement indicates whether in-bound roamers are allowed to access the broadcast MBS service or service class. SMF 120/MB-SMF 130/V-AF/NEF 140/UDM 150 and UE 110 may be similar to NE 2210 and UE 2220, as illustrated in FIG. 22, according to certain example embodiments. Certain example embodiments may relate to broadcast session roaming restrictions via service announcement, wherein the service announcement of broadcast service may indicate whether inbound roamers are allowed to access the broadcast service. Additionally, the service announcement may include a list of PLMNs corresponding to the HPLMNs of those inbound roamers which are allowed to access the broadcast service.

At operation 101, a service announcement may indicate whether in-bound roamers are allowed to access the broadcast MBS service, possibly with the PLMNs of allowed (or disallowed) in-bound roamers and/or an MBS service class.

V-AF/NEF 140 (attached to the VPLMN) may be configured with MBS service class and/or authorization information, and/or it may obtain the authorization from the VPLMN when requesting the establishment of an MBS broadcast session. For example, during the establishment of a broadcast MBS session, V-AF/NEF 140 may indicate to NEF 140/MB-SMF 130 whether the broadcast MBS session is open to (i.e., allowed to be accessed by) inbound roamers from all or specific HPLMNs, and/or it may provide the MBS service class of the broadcast MBS service. Alternatively, NEF 140 may be configured with a mapping of AF IDs and/or MBS session IDs to service classes, and/or may add the service class when forwarding an MBS session establishment request to MB-SMF 130. In various example embodiments, the mapping of MBS session IDs to service classes is configured in a database of the VPLMN and looked up by NEF 140 and/or MB-SMF 130 in the VPLMN.

In some example embodiments, NEF 140 and/or MB-SMF 130 may provide the service class in the response to the MBS session establishment request to V-AF/NEF 140. V-AF/NEF 140 and/or MB-SMF 130 may also indicate in the response to the establishment of an MBS session whether in-bound roamers are allowed to access the broadcast MBS service, possibly with the PLMNs of allowed (or disallowed) in-bound roamers. If V-AF/NEF 140 encrypts the broadcast data V-AF/NEF 140 provides, V-AF/NEF 140 may only provide keys enabling the description to roaming users which are authorized to use the service.

At operation 102, if the service announcement at operation 101 indicates that UE 110 is not authorized for roaming, UE 110 may not receive the broadcast, and may not need to send an MBS interest indication. For example, UEs in a VPLMN interested in a broadcast session which are not authorized for inbound roamers by service announcement may abstain from receiving the broadcast session and/or may not send an MBS interest indication containing that broadcast session. In various example embodiments, UEs in a VPLMN interested in a broadcast session, but for which the HPLMN is not authorized for inbound roamers by service announcement, may abstain from receiving the broadcast service and/or may not send an MBS interest indication containing that broadcast session. Furthermore, UE 110 may be configured with information about MBS service classes that UE 110 may access when roaming, possibly related to specific VPLMNs.

At operation 103, UE 110 may receive the broadcast and transmit an MBS interest indication for the service when in an RRC CONNECTED state. For example, UEs in a VPLMN interested in a broadcast session which are authorized for inbound roamers by service announcement may receive the broadcast service and/or send an MBS interest indication for this broadcast service. In addition, UEs in a VPLMN interested in a broadcast session for which the HPLMN is authorized for inbound roamers by service announcement may receive the broadcast service and/or may send an MBS interest indication for this broadcast service.

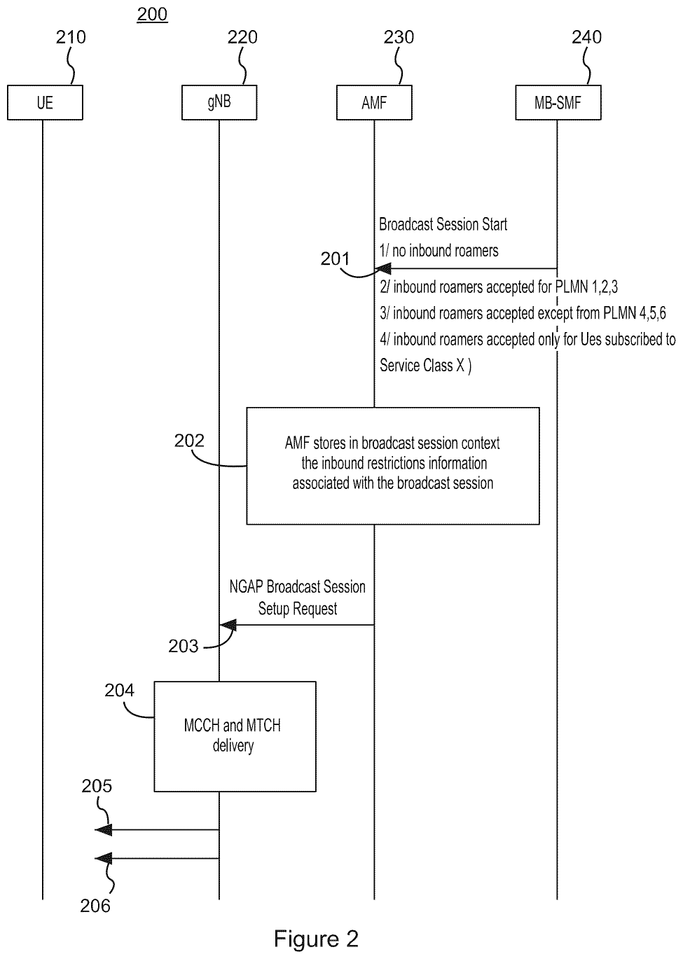

FIG. 2 illustrates an example of a signaling diagram 200 depicting inbound restrictions information sent by an MB-SMF and stored at an AMF. gNB 220/AMF 230/MB-SMF 240 and UE 210 may be similar to NE 2210 and UE 2220, as illustrated in FIG. 22, according to certain example embodiments. Some example embodiments may relate to VPLMN broadcast inbound restrictions checks by an AMF, wherein broadcast inbound-restrictions information may be sent at the start or update of a broadcast session and/or stored at an AMF.

At operation 201, at broadcast session start or update, MB-SMF 240 may send a new broadcast session start or update to AMF 230, including roaming restriction information. For example, the roaming restriction information may indicate any of that no inbound roamers are accepted; inbound roamers are accepted only for PLMNs 1, 2, 3 (e.g., whitelist); inbound roamers are accepted except for PLMNs 4, 5, 6 (e.g., blacklist); and/or inbound roamers are accepted only for UEs which have subscribed to service class X in the HPLMN.

At operation 202, AMF 230 may store the new roaming restriction information for future use.

At operation 203, AMF 230 may send a NGAP broadcast session setup request message to involved gNBs.

At operation 204, involved gNBs (e.g., gNB 220) may generate MCCH and MTCH corresponding to the broadcast session for delivery.

At operations 205 and 206, involved gNBs (e.g., gNB 220) may delivery the MCCH and MTCH, respectively.

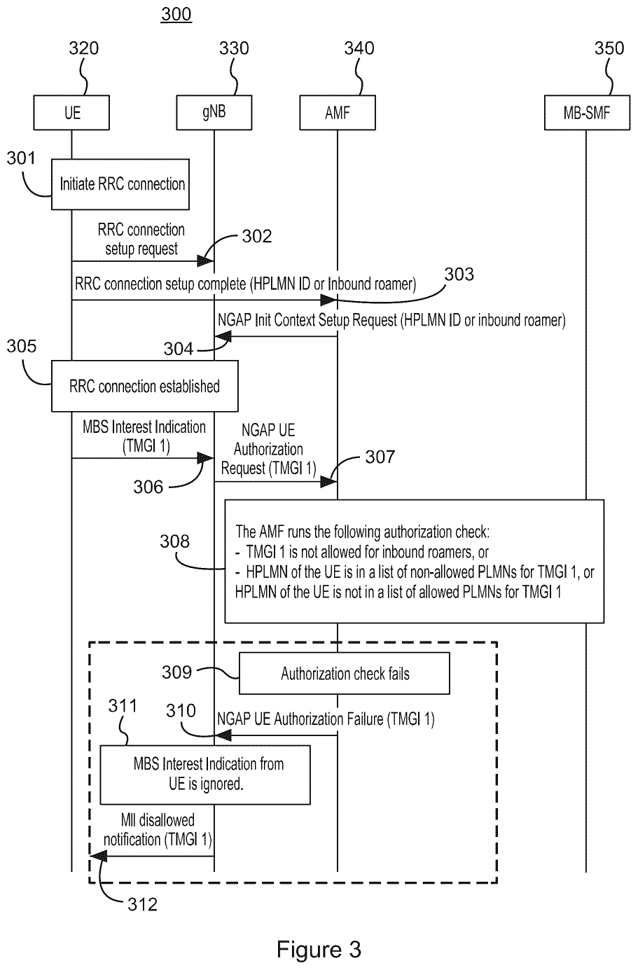

In a variation of FIG. 2, FIG. 3 illustrates an example of a signaling diagram 200 depicting VPLMN broadcast inbound restrictions check failure performed at an AMF. gNB 330/AMF 340/MB-SMF 350 and UE 320 may be similar to NE 2210 and UE 2220, as illustrated in FIG. 22, according to certain example embodiments. Initially, UE 320 may be in an RRC CONNECTED state.

At operation 301, UE 320 may initiate an RRC connection. At operation 302, UE 320 may transmit a RRC setup complete message to gNB 330 including a new information element indicating a UE 320 HPLMN ID (e.g., home PLMN identity) and/or an indication that it is an inbound roamer. This may be stored by gNB 330.

At operation 303, gNB 330 may inform the AMF that UE is getting RRC connected.

At operation 304, upon receiving 303, AMF 340 may transmit to gNB 330 an NGAP initial context setup request message, which may include a new information element indicating a UE 320 HPLMN ID (i.e., home PLMN identity) and/or an indication that it is an inbound roamer (alternative to operation 302). This may be stored by gNB 330.

At operation 305, UE 320 is operating in RRC connected state with gNB 330 following operations 301 to 304.

At operation 306, UE 320 may transmit to gNB 330 an MBS interest indication for a broadcast session identified by TMGI-1.

At operation 307, gNB 330 may transmit to AMF 340 an NGAP UE authorization request (e.g., TMGI 1), which may be configured to trigger a new NGAP authorization check procedure towards 5GC.

At operation 308, AMF 340 may run at least one authorization check including that TMGI1 is not allowed for inbound roamers, HPLMN of UE 320 is in a list of non-allowed PLMNs for TMGI 1, and that HPLMN of UE 320 is not in a list of allowed PLMNs for TMGI1.

At operation 309, AMF 340 may determine that one of the checks performed at operation 308 has meaning that the authorization is failed.

At operation 310, AMF 340 may transmit to gNB 330 an NGAP authorization failure message.

At operation 311, upon receiving the NGAP authorization failure message at operation 310, gNB 330 may ignore the MBS interest indication (MII) for the TMGI(s) that failed, but can still propagate the full received MII in case of handover.

At operation 312, gNB 330 may optionally transmit to UE 320 over RRC a notification that the corresponding broadcast service is disallowed.

In yet another variation of FIGS. 2 and 3, FIG. 4 illustrates an example of a signaling diagram 400 depicting VPLMN broadcast inbound restrictions check success performed at an AMF. gNB 430/AMF 440/MB-SMF 450 and UE 420 may be similar to NE 2210 and UE 2220, as illustrated in FIG. 22, according to certain example embodiments. Initially, UE 420 may be in an RRC CONNECTED state.

At operation 401, UE 420 may transmit to gNB 430 an RRC connection setup request.

At operation 402, UE 420 may transmit to gNB 430 a RRC connection setup complete message, which may include a new information element indicating UE 420 HPLMN ID (Home PLMN identity) and/or an indication that it is an inbound roamer. This may be stored by gNB 430.

At operation 403, upon receiving an NGAP Initial UE Message from gNB 430, AMF 440 may alternatively transmit to gNB 430 an NGAP initial context setup request message, which may include a new information element indicating UE 420 HPLMN ID (Home PLMN Identity) and/or an indication that it is an inbound roamer. This may be stored by gNB 430.

At operation 404, UE 420 may operate in RRC connected state with gNB 430 following operations 401 to 403.

At operation 405, UE 420 may transmit to gNB 430 an MII for a broadcast session identified by TMGI-1.

At operation 406, gNB 430 may transmit to AMF 440 a new NGAP authorization check request towards 5GC.

At operation 407, AMF 440 may perform an authorization check of any of that TMGI1 is not allowed for inbound roamers, HPLMN of UE 420 is in a list of non-allowed PLMNs for TMGI-1, and/or HPLMN of UE 420 is not in a list of allowed PLMNs for TMGI-1.

At operation 408, AMF 440 may not match one of the checks performed at operation 407, and thus the authorization is successful.

At operation 409, AMF 440 may transmit to gNB 430 an NGAP authorization response message.

At operation 410, upon receiving the NGAP authorization response message, gNB 430 may store the MII for the broadcast session TMGI-1 and/or uses the MII for the broadcast session TMGI-1 to steer the UE 420 to a cell/band (optionally PLMN) supporting TMGI-1.

At operation 411, gNB 430 may optionally send to UE 420 over RRC a notification that the corresponding broadcast service is allowed.

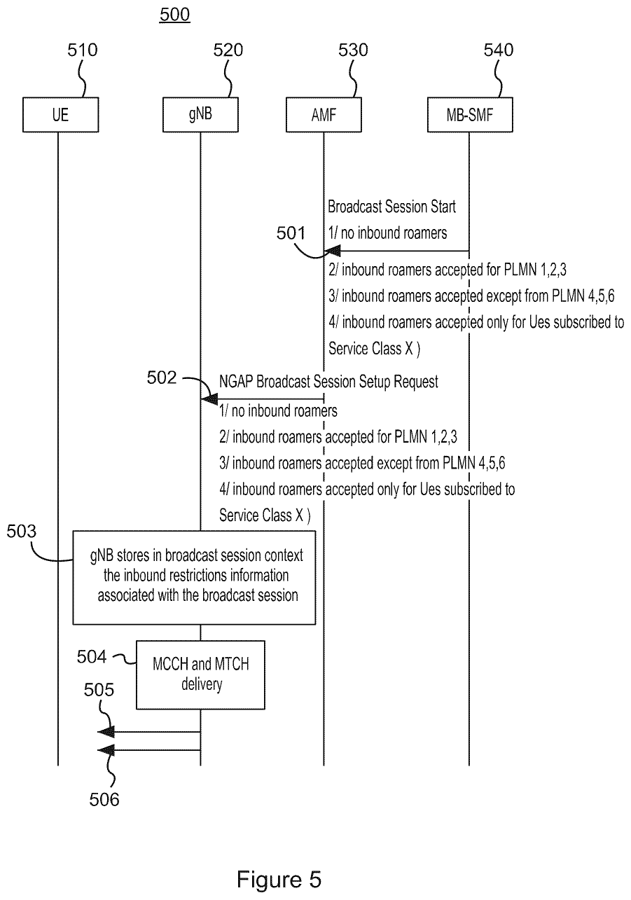

FIG. 5 illustrates an example of a signaling diagram 500 depicting broadcast inbound-restrictions checks in the NG-RAN node. gNB 520/AMF 530/MB-SMF 540 and UE 510 may be similar to NE 2210 and UE 2220, as illustrated in FIG. 22, according to certain example embodiments. Some example embodiments may relate to broadcast inbound-restrictions information sent at a broadcast session start and stored in NG-RAN.

At operation 501, at broadcast session start or update, MB-SMF 540 may send a new broadcast session start or update to AMF 530 including roaming restriction information. For example, the roaming restriction information may indicate any of that no inbound roamers are accepted, inbound roamers accepted only for PLMNs 1, 2, 3, inbound roamers are accepted except for PLMNs 4, 5, 6, and/or inbound roamers accepted only for UEs which have subscribed to service class X in the HPLMN.

At operation 502, AMF 530 may transmit to gNB 520 a new NGAP broadcast session setup or modification request to NG-RAN node (e.g., gNB) including the roaming restriction information received at operation 501.

At operation 503, gNB 520 may store the new roaming restriction information for future use.

At operation 504, gNB 520 may generate MCCH and MTCH corresponding to the broadcast session.

At operations 505 and 506, gNB 520 may transmit to UE 510 the MCCH and MTCH generated at operation 504.

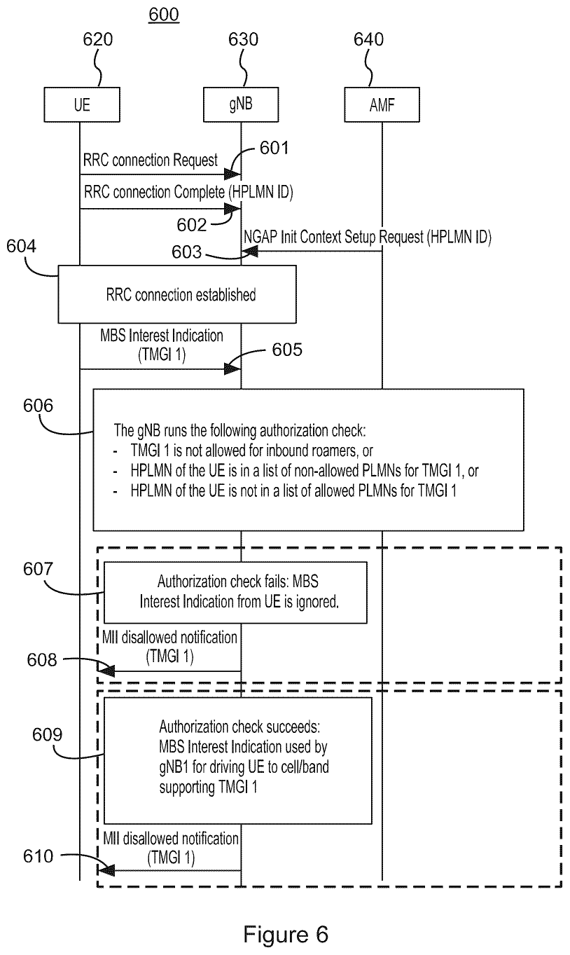

FIG. 6 illustrates an example of a signaling diagram 600 depicting VPLMN broadcast inbound restrictions check in NG-RAN node. gNB 520/AMF 530/MB-SMF 540 and UE 510 may be similar to NE 2210 and UE 2220, as illustrated in FIG. 22, according to certain example embodiments. Some example embodiments may relate to broadcast inbound-restrictions information sent at a broadcast session start and stored in NG-RAN.

At operation 601, UE 620 may request an RRC connection with gNB 630.

At operation 602, UE 620 may transmit an RRC connection complete (HPLMN ID) message to gNB 630, which may include a new information element indicating the UE's HPLMN ID (Home PLMN Identity). gNB 630 may store this information.

At operation 603, upon receiving the NGAP Initial UE Message from gNB 630 at operation 602, AMF 640 may transmit to gNB 630 a new NGAP initial context setup request including the identity of the HPLMN of UE 620 (HPLMN ID). This may be stored by gNB 630.

At operation 604, UE 620 may operate in RRC connected state with gNB 630 following operations 601 through 603.

At operation 605, while UE 620 is RRC connected mode, UE 620 may indicate to gNB 630 an MBS interest indication for a broadcast session identified by TMGI-1.

At operation 606, gNB 630 may perform authorization checks including any of that the TMGI1 is not allowed for inbound roamers, the HPLMN of UE 620 is in a list of non-allowed PLMNs for TMGI 1, and/or HPLMN of UE 620 is not in a list of allowed PLMNs for TMGI1.

At operation 607, gNB 630 may determine that one of the checks at operation 607 indicates that the authorization is failed: MBS Interest Indication from UE 620 may be ignored for the TMGI(s) like TMGI-1 that failed (but full MII is still be propagated in case of handover).

At operation 608, gNB 630 may optionally transmit to UE 620 over RRC a notification that the corresponding broadcast service is disallowed.

At operation 609, gNB 630 may not match one of the checks at operation 606, meaning that the authorization is successful: MBS interest indication from UE 620 for the broadcast session identified by TMGI-1 is used by gNB 630 for subsequent steering UE 620 to cells/bands (optionally PLMN) supporting TMGI-1.

At operation 610, gNB 630 may optionally send to UE 620 over RRC a notification that the corresponding broadcast service is allowed.

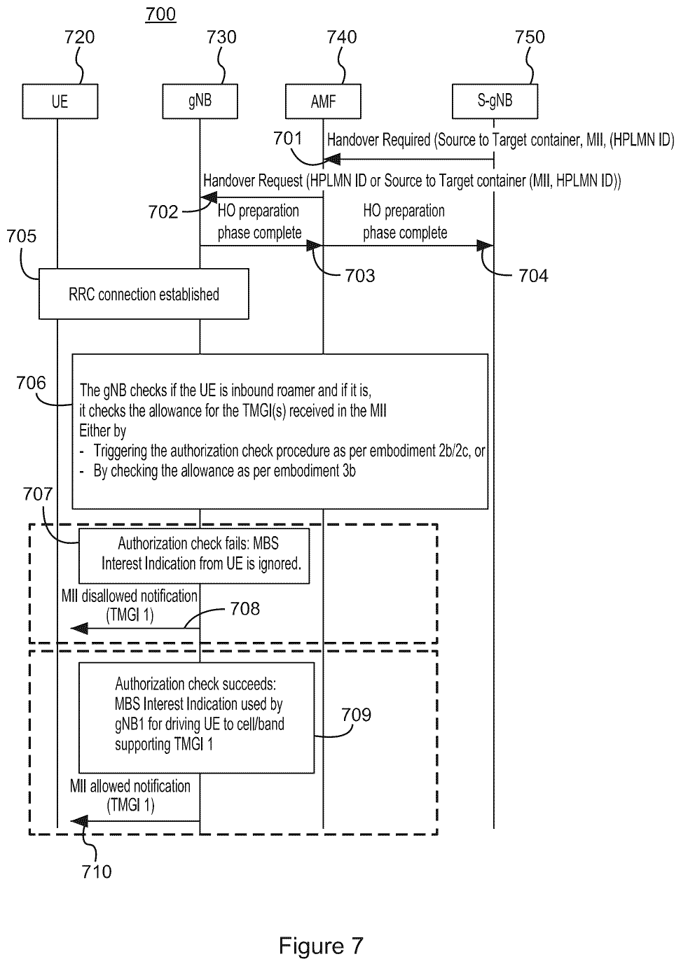

FIG. 7 illustrates an example of a signaling diagram 700 depicting inbound broadcast service restriction checks in case of inter-PLMN handover. gNB 730/AMF 740/source (S)-gNB 750 and UE 720 may be similar to NE 2210 and UE 2220, as illustrated in FIG. 22, according to certain example embodiments.

At operation 701, s-gNB 750 may indicate to AMF 740 that a handover is required, including a source-to-target container, MII, and/or HPLMN ID.

At operation 702, AMF 740 may transmit the HPLMN ID of UE 720 in a NGAP handover request message, and/or may include an indication that UE 720 is an inbound roamer. Target gNB 730 may receive the HPLMN ID in the source-to-target container from s-gNB 720, in the handover request message from AMF 740, and/or may receive an indication that UE 720 is an inbound roamer in the NGAP handover request from AMF 740. Target gNB 730 may also receive the MII for the broadcast session identified by TMGI-1 in the source to target container from S-gNB 750 included in the NGAP Handover Request sent by AMF at operation 702.

At operations 703 and 704, the handover preparation phase completes.

At operation 705, UE 720 is operating in RRC connected state with gNB 730.

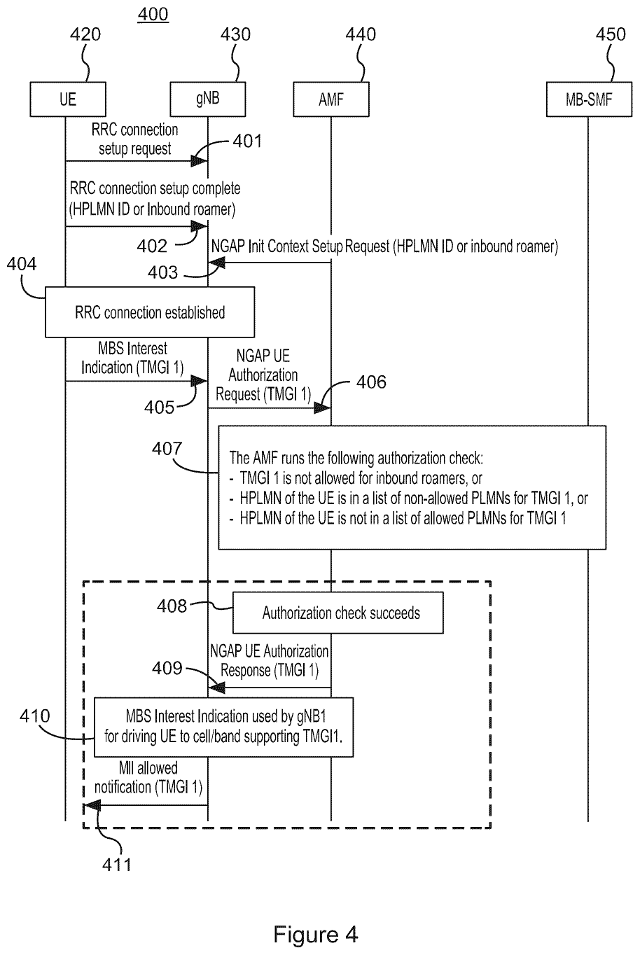

At operation 706, target gNB 730 may determine if UE 720 is an inbound roamer using the received HPLMN ID and/or the received inbound roamer indication. If UE 720 is an inbound roamer, target gNB 730 may check the allowance for the broadcast services indicated in the received MII by the TMGI(s) using any of triggering the authorization check procedure (either AMF authorization check as in FIGS. 3-4 or gNB authorization check as in FIGS. 5-6); checking the allowance (as in FIG. 6).

At operation 707, if authorization check fails for some TMGIs of the MII, target gNB 730 may ignore the interest indication for those TMGI(s) which failed (but may still propagate the full MII during handover). At operation 708, target gNB 730 may optionally transmit to UE 720 an MII disallowed notification for the concerned TMGI(s) to notify UE 720 of the failure.

At operation 709, if authorization check succeeds for some TMGIs of the MII, target gNB 730 may consider the interest indication for the relevant TMGIs to preferably steer UE 720 to cell/band (optionally PLMN) supporting the TMGI 1. At operation 710, gNB 730 may optionally transmit a MII allowed notification (for allowed TMGI(s) e.g., TMGI 1) to UE 720 to notify UE 720 of the success.

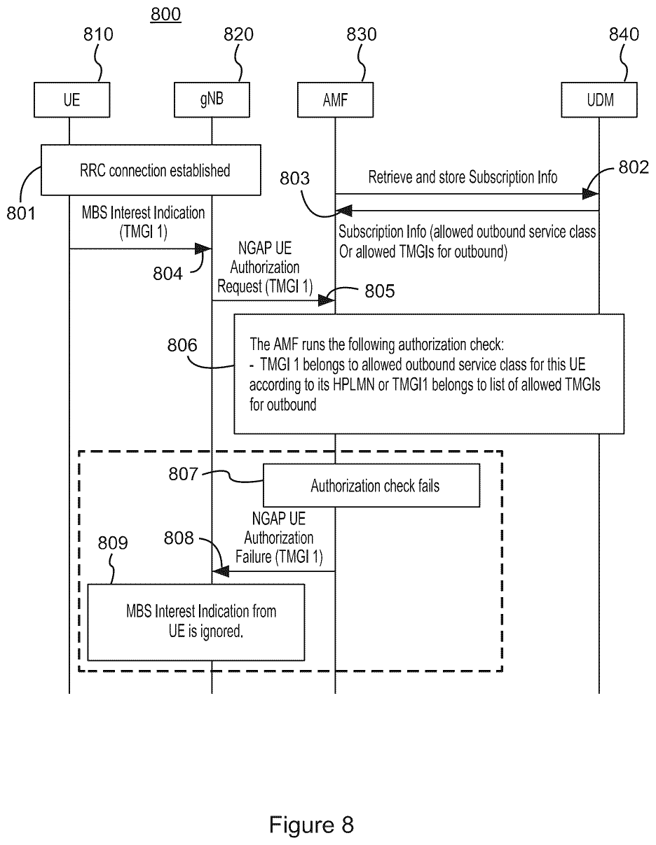

FIG. 8 illustrates an example of a signaling diagram 800 depicting broadcast outbound restrictions checks between a gNB and AMF. gNB 720/AMF 830/UDM 840 and UE 810 may be similar to NE 2210 and UE 2220, as illustrated in FIG. 22, according to certain example embodiments. For example, various example embodiments may check for H-PLMN outbound broadcast service class failures.

At operation 801, UE 810 and gNB 820 may establish an RRC connection.

At operation 802, AMF 830 may request from UDM 840 subscription information for UE 810. At operation 803, UDM 840 may transmit to AMF 830 the requested subscription information, which may include an “allowed outbound service class” or an “allowed outbound list of TMGIs.”

At operation 804, UE 810 may transmit to gNB 820 an MII for a broadcast session identified by TMGI-1.

At operation 805, gNB 820 may transmit to AMF 830 a new NGAP authorization check procedure towards 5GC.

At operation 806, AMF 830 may perform authorization checks including whether TMGI1 belongs to allowed outbound service class for this UE according to its HPLMN or TMGI1 belongs to the list of allowed TMGIs for outbound roaming.

At operation 807, AMF 830 may not match the check meaning that the authorization is failed.

At operation 808, AMF 830 may transmit to gNB 820 an NGAP authorization failure message.

At operation 809, upon receiving the NGAP authorization failure message at operation 808, gNB 820 may ignore the MII for TMGI-1, and may propagate the full MII in case of handover.

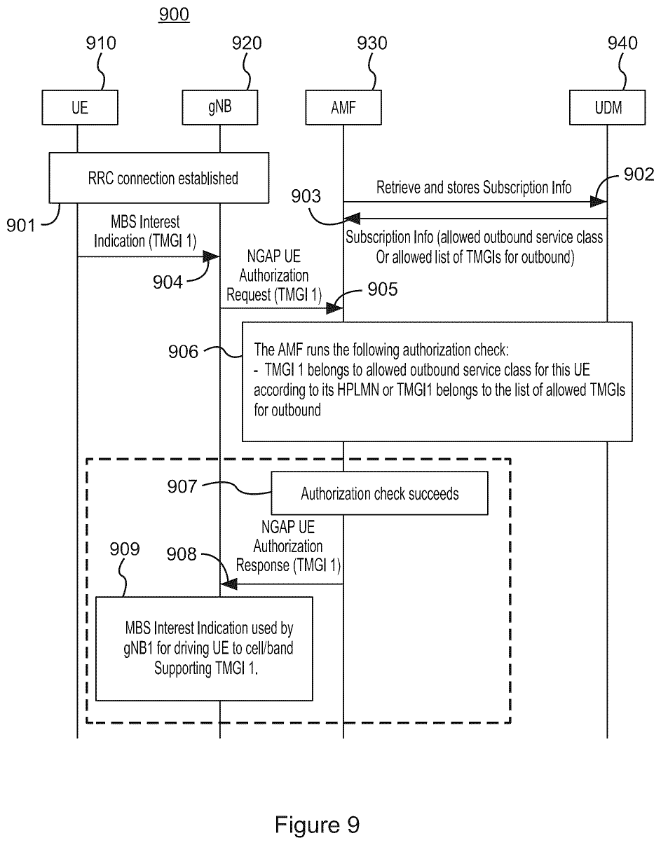

FIG. 9 illustrates an example of a signaling diagram 900 depicting checking of H-PLMN outbound broadcast service class success. gNB 920/AMF 930/UDM 940 and UE 910 may be similar to NE 2210 and UE 2220, as illustrated in FIG. 22, according to certain example embodiments. For example, various example embodiments may relate to H-PLMN outbound broadcast service restrictions check successes.

At operation 901, UE 910 and gNB 920 may establish an RRC connection.

At operation 902, AMF 930 may request subscription information from UDM 940. At operation 903, UDM 940 may transmit to AMF 930 the requested subscription information, including an “allowed outbound service class” or an “allowed outbound list of TMGIs.”

At operation 904, UE 910 may indicate to gNB 920 an MII for broadcast session identified by TMGI 1.

At operation 905, gNB 920 may transmit to AMF 930 a NGAP authorization check request towards 5GC.

At operation 906, AMF 930 may perform an authorization check including that TMGI1 belongs to allowed outbound service class for this UE according to its HPLMN and/or that TMGI1 belongs to the list of allowed TMGIs for outbound roaming.

At operation 907, AMF 930 may match the check meaning that the authorization is successful.

At operation 908, AMF transmit an NGAP authorization response message to gNB 920.

At operation 910, upon receiving the NGAP authorization response message at operation 909, gNB 920 may store the MII for the concerned TMGI(s) and use it to further steer UE 910 to cell/band (optionally PLMN) supporting TMGI 1.

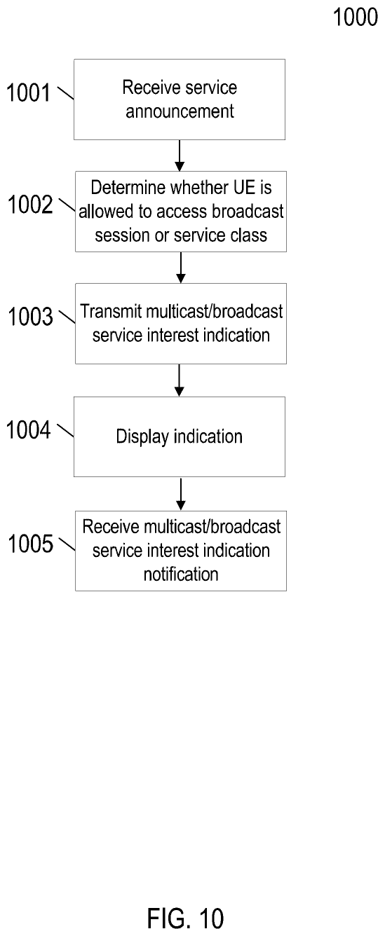

FIG. 10 illustrates an example of a flow diagram of a method 1000 that may be performed by a UE, such as UE 2220 illustrated in FIG. 22, according to various example embodiments.

At step 1001, the method may include receiving, by a user equipment attached to a PLMN as an inbound roamer, a service announcement for a broadcast session or service class indicating whether inbound roamers are allowed to access the broadcast service or service class.

At step 1002, the method may further include determining, based on the service announcement, whether the user equipment is allowed to access a broadcast session or service class in the PLMN. In certain example embodiments, the determining may be based at least upon the service announcement indicating at least one home PLMN of allowed or disallowed inbound roamers and at least one home PLMN of the UE.

At step 1003, the method may further include, in response to determining that the user equipment is allowed to access a broadcast session or service class in the PLMN, transmitting, by the user equipment, a multicast/broadcast service interest indication associated with the broadcast session or service class upon completion of a radio resource request.

At step 1004, the method may further include, in response to determining that the user equipment is allowed to access a broadcast session or service class in the PLMN, displaying, by the user equipment, an indication of whether the broadcast session or service class is accessible.

At step 1005, the method may further include receiving a multicast/broadcast service interest indication allowed notification or multicast/broadcast service interest indication disallowed notification associated with the broadcast session or service class.

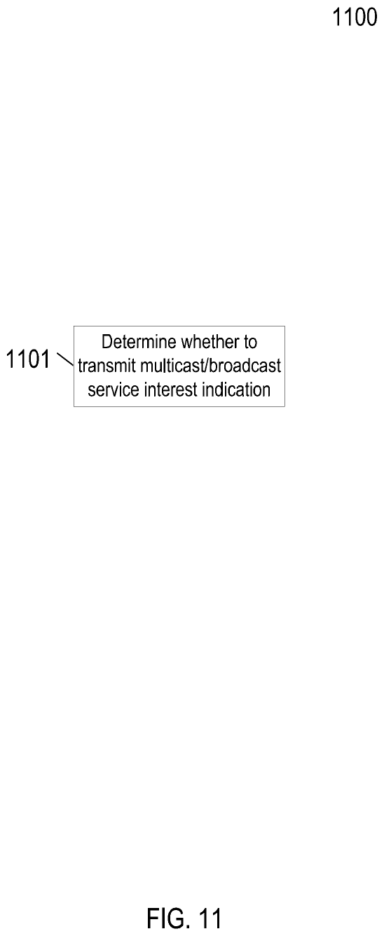

FIG. 11 illustrates an example of a flow diagram of a method 1100 that may be performed by a UE, such as UE 2220 illustrated in FIG. 22, according to various example embodiments.

At step 1101, the method may include determining, by a user equipment roaming in a visited PLMN, whether to transmit a multicast/broadcast service interest indication associated with a particular broadcast service class upon a radio resource request completed based on a configuration. The configuration may include a list of PLMNs where the UE is allowed to transmit a multicast/broadcast service interest indication associated with a particular broadcast service class upon a radio resource request completed.

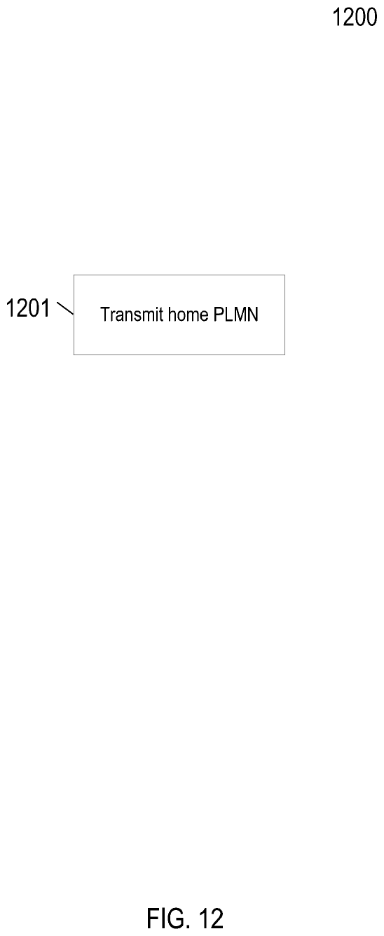

FIG. 12 illustrates an example of a flow diagram of a method 1200 that may be performed by a UE, such as UE 2220 illustrated in FIG. 22, according to various example embodiments.

At step 1201, the method may include transmitting, by a user equipment, a home PLMN identifier or an inbound roamer indication in a radio resource control message.

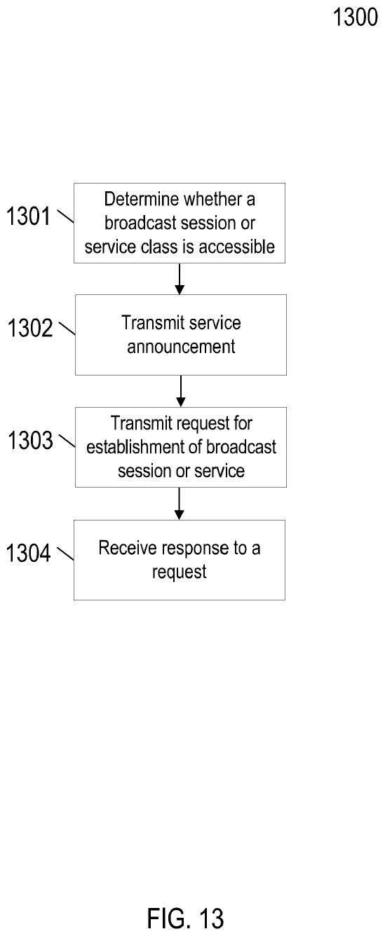

FIG. 13 illustrates an example of a flow diagram of a method 1300 that may be performed by a NE, such as NE 2210 illustrated in FIG. 22, according to various example embodiments.

At step 1301, the method may include determining, by a first network entity, whether a broadcast session or service class is accessible by inbound roamers.

At step 1302, the method may include in response to determining that a broadcast session or service class is accessible by inbound roamers, transmitting, by the first network entity, a service announcement for a broadcast session or service class indicating whether inbound roamers are allowed to access the broadcast service or service class. The service announcement may indicate at least one home PLMN of allowed or disallowed inbound roamers.

In some example embodiments, the determination may be based at least upon configured information.

At step 1303, the method may include transmitting a request for establishment of the broadcast session or service to a second network entity. The request may include an indication of whether inbound roamers are allowed to access the broadcast session or service.

At step 1304, the method may further include receiving a response to a request comprising a second indication of whether inbound roamers are allowed to access the broadcast session or service. The determining may be based at least upon the second indication, and the request may indicate at least one service class.

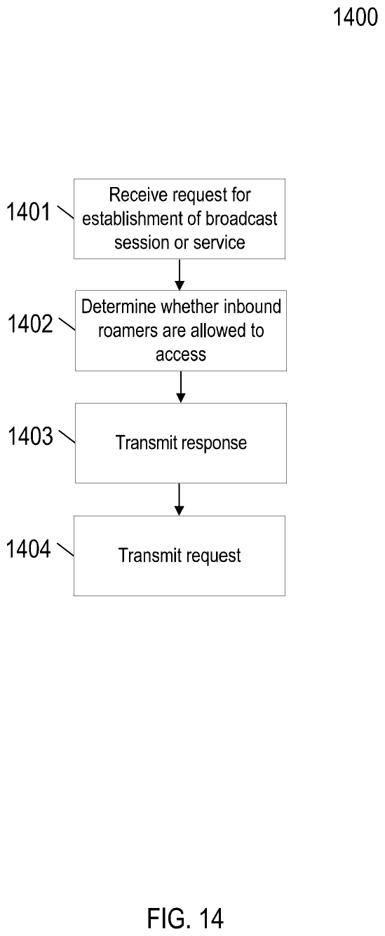

FIG. 14 illustrates an example of a flow diagram of a method 1400 that may be performed by a NE, such as NE 2210 illustrated in FIG. 22, according to various example embodiments.

At step 1401, the method may include receiving, by a first network entity, a request for the establishment of a broadcast session or service from a second network entity. The request may indicate at least one service class.

At step 1402, the method may further include determining whether inbound roamers are allowed to access the broadcast session or service. The determining may be based upon at least one of an identity of the second network entity, the at least one service class, configured information, or information obtained from a database.

At step 1403, the method may further include transmitting a response to the request indicating whether inbound roamers are allowed to access the broadcast session or service.

At step 1404, the method may further include transmitting a request to establish or start the broadcast session or service comprising an indication of whether inbound roamers are allowed to access the broadcast session or service.

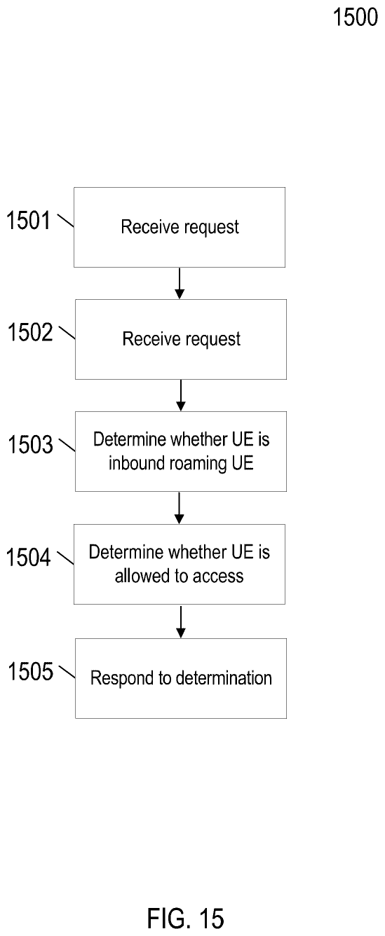

FIG. 15 illustrates an example of a flow diagram of a method 1500 that may be performed by a NE, such as NE 2210 illustrated in FIG. 22, according to various example embodiments.

At step 1501, the method may include receiving, by a first network entity, a request from a second network entity to establish a broadcast session or service.

At step 1502, the method may further include receiving, by the first network entity, a request from a user equipment for user service registration for the broadcast service.

At step 1503, the method may further include determining, by the first network entity, whether the user equipment is an inbound roaming user equipment. The determining may be based upon at least one of an identity of the second network entity, a home PLMN of the user equipment, roaming restriction information for the broadcast session or service received within the request for the establishment of the broadcast session or service, a service class received in the request for the establishment of the broadcast session or service, roaming restriction information for the at least one service class, the at least one broadcast session or service, or at least one home PLMN retrieved from a database, or configured roaming restriction information for the at least one service class, at least one broadcast session or service, or at least one home PLMN.

At step 1504, the method may further include, in response to determining that the user equipment is an inbound roaming user equipment, determining whether the user equipment is allowed to access the broadcast session or service.

At step 1505, the method may further include, based upon the determination of whether the user equipment is allowed to access the broadcast session or service, accepting the request from the user equipment, and providing a multicast broadcast service key to the user equipment, or rejecting the request from the user equipment. For example, the rejection of the request of the user equipment may include at least a cause value configuring the user equipment to cease retrying the user service registration for the broadcast service.

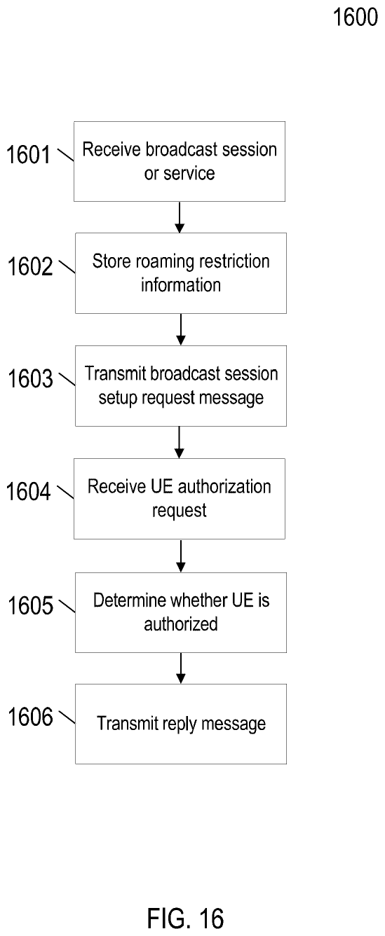

FIG. 16 illustrates an example of a flow diagram of a method 1600 that may be performed by a NE, such as NE 2210 illustrated in FIG. 22, according to various example embodiments.

At step 1601, the method may include receiving, by a first network entity, a broadcast session or service start or update comprising roaming restriction information.

At step 1602, the method may further include storing, by the first network entity, the roaming restriction information for the broadcast session or service.

At step 1603, the method may further include transmitting, by the first network entity, a next generation application protocol broadcast session setup or modification request message to a second network entity.

At step 1604, the method may further include receiving, by the first network entity, a next generation application protocol user equipment authorization request from the second network entity comprising an identifier of the broadcast session or service, and an identifier of the user equipment.

At step 1605, the method may further include determining, by the first network entity, based on roaming restriction information for the broadcast session or service whether the user equipment is authorized to receive the broadcast session or service.

At step 1606, the method may further include transmitting, by the first network entity, a next generation application protocol user equipment authorization reply message to the second network entity indicating whether the user equipment is authorized to receive the broadcast session or service.

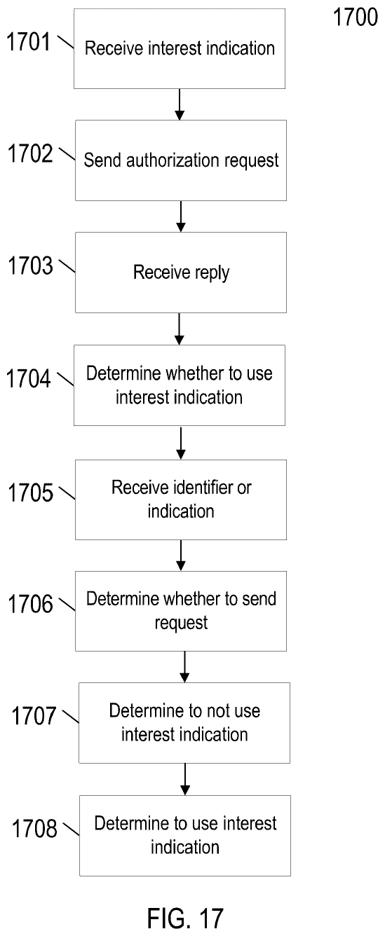

FIG. 17 illustrates an example of a flow diagram of a method 1700 that may be performed by a NE, such as NE 2210 illustrated in FIG. 22, according to various example embodiments.

At step 1701, the method may include receiving, by a first network entity, an interest indication for a broadcast session or service for a user equipment. The interest indication may be received from at least one of a radio resource control message from the user equipment, a next generation application protocol handover request message from a core network entity, or a source to target container from a peer RAN network entity.

At step 1702, the method may further include sending, by the first network entity, a next generation application protocol user equipment authorization request comprising an identifier of the broadcast session or service, and an identifier of the user equipment to a second network entity.

At step 1703, the method may further include receiving, by the first network entity, a next generation application protocol user equipment authorization reply message from the second network entity comprising an indication of whether the user equipment is authorized to receive the broadcast session or service.

At step 1704, the method may further include, based upon the authorization indication, determining whether to take into consideration the user equipment interest indication for the broadcast session or service.

At step 1705, the method may further include receiving a home PLMN identifier or an inbound roamer indication associated with the user equipment from at least one of a next generation application protocol initiation context setup request from a core network entity, a next generation application protocol handover request message from a core network entity, a source to target container from a peer RAN network entity, or a radio resource control message from a user equipment.

At step 1706, the method may further include determining, based on the inbound roamer indication or the home PLMN identifier differing from the PLMN identifier of the PLMN where the network entity is located, whether to send the next generation application protocol user equipment authorization request.

At step 1707, the method may further include upon determining to not take into consideration the user equipment interest indication for the broadcast session or service, performing at least one of ignoring the multicast/broadcast interest indication from the user equipment, or transmitting to the user equipment a multicast/broadcast service interest indication disallowed notification for the broadcast session.

At step 1708, the method may further include, upon determining to take into consideration the user equipment interest indication for the broadcast session or service, performing at least one of steering the user equipment to a frequency suitable to receive the broadcast service corresponding to the temporary mobile group identity or service class indicated in the multicast/broadcast interest indication or transmitting to the user equipment a multicast/broadcast service interest indication allowed notification for the broadcast session.

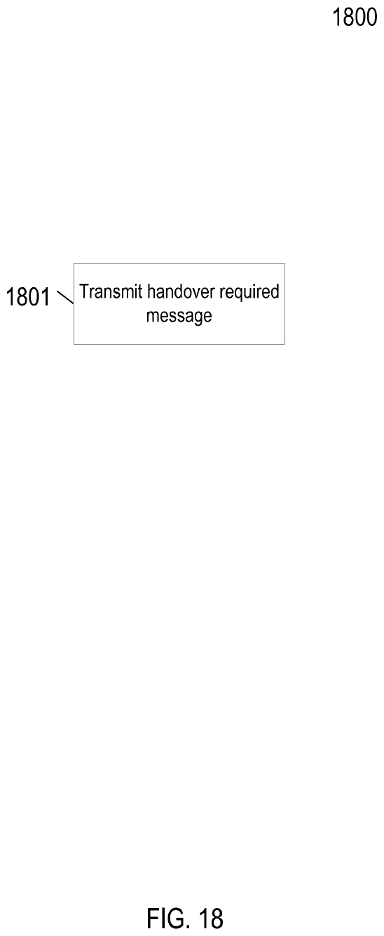

FIG. 18 illustrates an example of a flow diagram of a method 1800 that may be performed by a NE, such as NE 2210 illustrated in FIG. 22, according to various example embodiments.

At step 1801, the method may include transmitting a handover required message for the user equipment comprising at least one of a home PLMN identifier, an inbound roamer indication, or a multicast/broadcast interest indication configured for the user equipment.

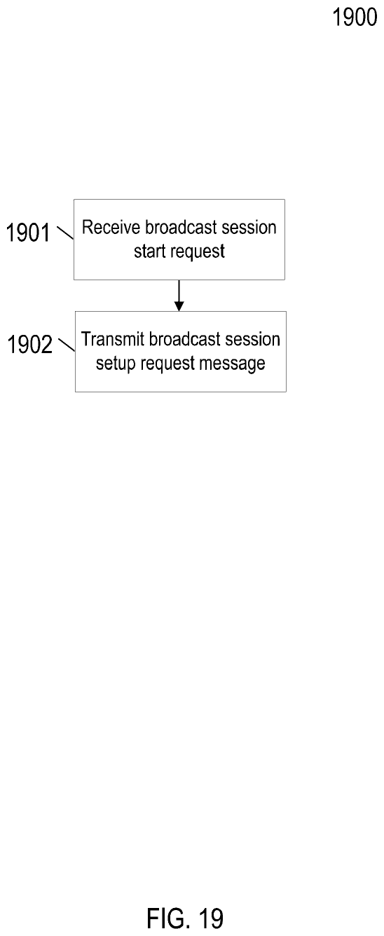

FIG. 19 illustrates an example of a flow diagram of a method 1800 that may be performed by a NE, such as NE 2210 illustrated in FIG. 22, according to various example embodiments.

At step 1901, the method may include receiving, by a first network entity, a broadcast session start or update request for a broadcast session comprising roaming restriction information.

At step 1902, the method may further include transmitting, by the first network entity, at least one next generation application protocol broadcast session setup request or modification message to a second network entity configured for a broadcast session comprising the roaming restriction information.

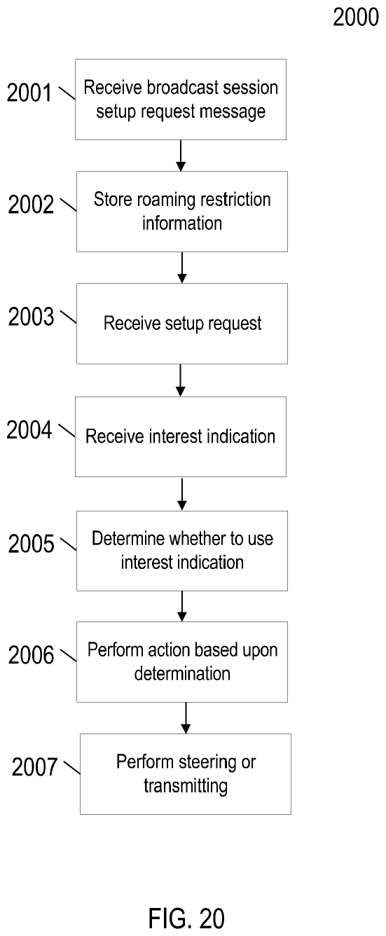

FIG. 20 illustrates an example of a flow diagram of a method 1900 that may be performed by a NE, such as NE 2210 illustrated in FIG. 22, according to various example embodiments.

At step 2001, the method may include receiving, by a network entity, a next generation application protocol broadcast session setup or modification request message for a broadcast session from a core network entity comprising roaming restriction information.

At step 2002, the method may further include storing the roaming restriction information for the broadcast session.

At step 2003, the method may further include receiving, by the network entity, from a core network entity, at least one of a next generation application protocol initiation context setup request for a user equipment comprising a home PLMN identifier and a handover request message for a user equipment comprising a home PLMN identifier.

At step 2004, the method may further include receiving, by the network entity, an interest indication for the user equipment for the broadcast session. The interest indication for the UE for the broadcast session may be received by at least one of a radio resource control message from the user equipment, a handover request from a core network entity, or a source to target container from a peer radio access network entity.

At step 2005, the method may further include determining, by the network entity, based on the stored roaming restriction information and the home PLMN identifier of the user equipment, whether to take into consideration the user equipment interest indication for the broadcast session or service.

At step 2006, the method may further include, in response to determining to not take into consideration the user equipment interest indication for the broadcast session or service, performing, by the network entity, at least one of ignoring the interest indication for the broadcast session or service, or transmitting to the user equipment a multicast/broadcast service interest indication disallowed notification for the broadcast session.

At step 2007, the method may further include, in response to determining to take into consideration the user equipment interest indication for the broadcast session, performing, by the network entity, at least one of steering the user equipment to a frequency suitable to receive the broadcast service corresponding to the temporary mobile group identity or service class indicated in the interest indication, or transmitting a multicast/broadcast service interest indication allowed notification for the broadcast session.

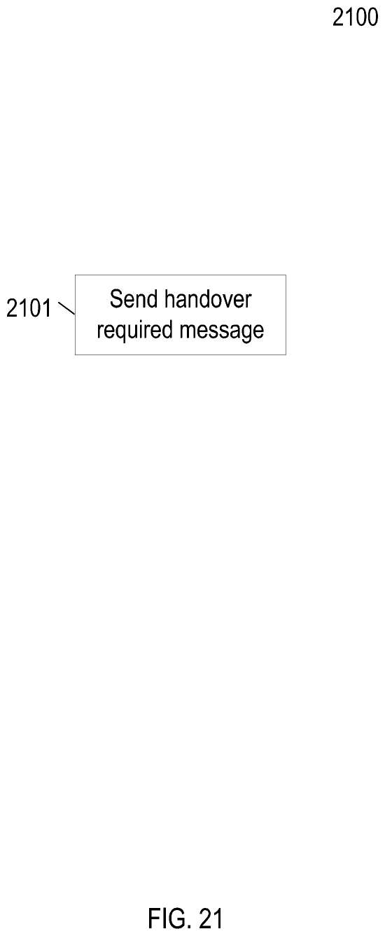

FIG. 21 illustrates an example of a flow diagram of a method 2000 that may be performed by a NE, such as NE 2210 illustrated in FIG. 22, according to various example embodiments.

At step 2101, the method may include sending a handover required message for a user equipment comprising a home PLMN identifier.

In any of the example embodiments described herein, roaming restriction information may indicate at least one of no inbound roamers are accepted, all inbound roamers are accepted, a list of home PLMN s from which inbound roamers are accepted, a list of home PLMN from which inbound roamers are rejected, or a service class.

FIG. 22 illustrates an example of a system according to certain example embodiments. In one example embodiment, a system may include multiple devices, such as, for example, NE 2210 and/or UE 2220.

NE 2210 may be one or more of a base station (e.g., 3G UMTS NodeB, 4G LTE Evolved NodeB, or 5G NR Next Generation NodeB), a serving gateway, a server, and/or any other access node or combination thereof.

NE 2210 may further include at least one gNB-centralized unit (CU), which may be associated with at least one gNB-distributed unit (DU). The at least one gNB-CU and the at least one gNB-DU may be in communication via at least one F1 interface, at least one Xn-C interface, and/or at least one NG interface via a 5^{th} generation core (5GC).

UE 2220 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 2210 and/or UE 2220 may be one or more of a citizens broadband radio service device (CBSD).

NE 2210 and/or UE 2220 may include at least one processor, respectively indicated as 2211 and 2221. Processors 2211 and 2221 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 2212 and 2222. The memory may be fixed or removable. The memory may include computer program instructions or computer code contained therein. Memories 2212 and 2222 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 2211 and 2221, memories 2212 and 2222, and any subset thereof, may be configured to provide means corresponding to the various blocks of FIGS. 1-21. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 22, transceivers 2213 and 2223 may be provided, and one or more devices may also include at least one antenna, respectively illustrated as 2214 and 2224. The device may have many antennas, such as an array of antennas configured for multiple input multiple output (MIMO) communications, or multiple antennas for multiple RATs. Other configurations of these devices, for example, may be provided. Transceivers 2213 and 2223 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 1-21). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 1-21. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

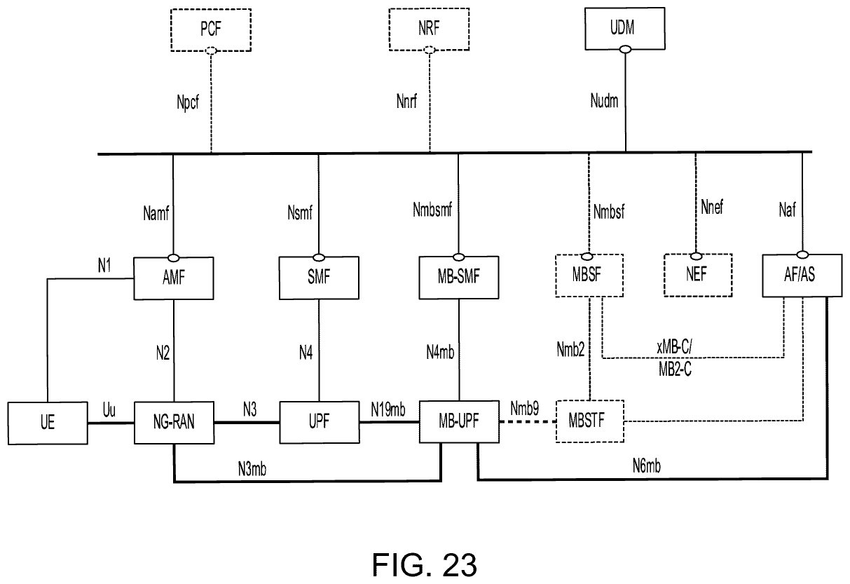

FIG. 23 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 23 may be similar to NE 2210 and UE 2220, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

According to certain example embodiments, processors 2211 and 2221, and memories 2212 and 2222, may be included in or may form a part of processing circuitry or control circuitry. In addition, in some example embodiments, transceivers 2213 and 2223 may be included in or may form a part of transceiving circuitry.

In some example embodiments, an apparatus (e.g., NE 2210 and/or UE 2220) may include means for performing a method, a process, or any of the variants discussed herein. Examples of the means may include one or more processors, memory, controllers, transmitters, receivers, and/or computer program code for causing the performance of the operations.

In various example embodiments, apparatus 2220 may be controlled by memory 2222 and processor 2221 to receive, when the apparatus is attached to a PLMN as an inbound roamer, a service announcement for a broadcast session or service class indicating whether inbound roamers are allowed to access the broadcast service or service class; determine, based on the service announcement, whether the apparatus is allowed to access a broadcast session or service class in the PLMN; and in response to determining that the apparatus is allowed to access a broadcast session or service class in the PLMN, transmit a multicast/broadcast service interest indication associated with the broadcast session or service class upon completion of a radio resource request.

Certain example embodiments may be directed to an apparatus that includes means for performing any of the methods described herein including, for example, means for receiving, when the apparatus is attached to a PLMN as an inbound roamer, a service announcement for a broadcast session or service class indicating whether inbound roamers are allowed to access the broadcast service or service class; means for determining, based on the service announcement, whether the apparatus is allowed to access a broadcast session or service class in the PLMN; and in response to determining that the apparatus is allowed to access a broadcast session or service class in the PLMN, transmitting a multicast/broadcast service interest indication associated with the broadcast session or service class upon completion of a radio resource request.

In various example embodiments, apparatus 2220 may be controlled by memory 2222 and processor 2221 to determine, when the apparatus is roaming in a visited PLMN, whether to transmit a multicast/broadcast service interest indication associated with a particular broadcast service class upon a radio resource request completed based on a configuration.

Certain example embodiments may be directed to an apparatus that includes means for performing any of the methods described herein including, for example, means for determining, when the apparatus is roaming in a visited PLMN, whether to transmit a multicast/broadcast service interest indication associated with a particular broadcast service class upon a radio resource request completed based on a configuration.

In various example embodiments, apparatus 2220 may be controlled by memory 2222 and processor 2221 to transmit a home PLMN or an inbound roamer indication in a radio resource control message.

Certain example embodiments may be directed to an apparatus that includes means for performing any of the methods described herein including, for example, means for transmitting a home PLMN or an inbound roamer indication in a radio resource control message.

In various example embodiments, apparatus 2210 may be controlled by memory 2212 and processor 2211 to determine whether a broadcast session or service class is accessible by inbound roamers, and in response to determining that a broadcast session or service class is accessible by inbound roamers, transmit a service announcement for a broadcast session or service class indicating whether inbound roamers are allowed to access the broadcast service or service class.

Certain example embodiments may be directed to an apparatus that includes means for performing any of the methods described herein including, for example, means for determining whether a broadcast session or service class is accessible by inbound roamers, and in response to determining that a broadcast session or service class is accessible by inbound roamers, transmitting a service announcement for a broadcast session or service class indicating whether inbound roamers are allowed to access the broadcast service or service class.

In various example embodiments, apparatus 2210 may be controlled by memory 2212 and processor 2211 to receive a request for the establishment of a broadcast session or service from a network entity, determine whether inbound roamers are allowed to access the broadcast session or service, and transmit a response to the request indicating whether inbound roamers are allowed to access the broadcast session or service.

Certain example embodiments may be directed to an apparatus that includes means for performing any of the methods described herein including, for example, means for receiving a request for the establishment of a broadcast session or service from a network entity, means for determining whether inbound roamers are allowed to access the broadcast session or service, and means for transmitting a response to the request indicating whether inbound roamers are allowed to access the broadcast session or service.

In various example embodiments, apparatus 2210 may be controlled by memory 2212 and processor 2211 to receive a request from a network entity to establish a broadcast session or service, receive a request from a user equipment for user service registration for the broadcast service, determine whether the user equipment is an inbound roaming user equipment, in response to determining that the user equipment is an inbound roaming user equipment, determine whether the user equipment is allowed to access the broadcast session or service, and based upon the determination of whether the user equipment is allowed to access the broadcast session or service, accept the request from the user equipment, and provide a multicast broadcast service key to the user equipment, or reject the request from the user equipment.

Certain example embodiments may be directed to an apparatus that includes means for performing any of the methods described herein including, for example, means for receiving a request from a network entity to establish a broadcast session or service, means for receiving a request from a user equipment for user service registration for the broadcast service, means for determining whether the user equipment is an inbound roaming user equipment, means for, in response to determining that the user equipment is an inbound roaming user equipment, determining whether the user equipment is allowed to access the broadcast session or service, and means for, based upon the determination of whether the user equipment is allowed to access the broadcast session or service, accepting the request from the user equipment, and providing a multicast broadcast service key to the user equipment, or rejecting the request from the user equipment.

In various example embodiments, apparatus 2210 may be controlled by memory 2212 and processor 2211 to receive a broadcast session or service start comprising roaming restriction information, store the roaming restriction information for the broadcast session or service, transmit a next generation application protocol broadcast session setup request message to a network entity, receive a next generation application protocol user equipment authorization request from the network entity comprising an identifier of the broadcast session or service, and an identifier of the user equipment, determine based on roaming restriction information for the broadcast session or service whether the user equipment is authorized to receive the broadcast session or service, and transmit a next generation application protocol user equipment authorization reply message to the network entity indicating whether the user equipment is authorized to receive the broadcast session or service.

Certain example embodiments may be directed to an apparatus that includes means for performing any of the methods described herein including, for example, means for receiving a broadcast session or service start comprising roaming restriction information, means for storing the roaming restriction information for the broadcast session or service, means for transmitting a next generation application protocol broadcast session setup request message to a network entity, means for receiving a next generation application protocol user equipment authorization request from the network entity comprising an identifier of the broadcast session or service, and an identifier of the user equipment, means for determining based on roaming restriction information for the broadcast session or service whether the user equipment is authorized to receive the broadcast session or service, and means for transmitting a next generation application protocol user equipment authorization reply message to the network entity indicating whether the user equipment is authorized to receive the broadcast session or service.

In various example embodiments, apparatus 2210 may be controlled by memory 2212 and processor 2211 to receive an interest indication for a broadcast session or service for a user equipment, send a next generation application protocol user equipment authorization request comprising an identifier of the broadcast session or service, and an identifier of the user equipment to a network entity, receive a next generation application protocol user equipment authorization reply message from the network entity comprising an indication of whether the user equipment is authorized to receive the broadcast session or service, and based upon the authorization indication, determine whether to take into consideration the user equipment interest indication for the broadcast session or service.

Certain example embodiments may be directed to an apparatus that includes means for performing any of the methods described herein including, for example, means for receiving an interest indication for a broadcast session or service for a user equipment, means for sending a next generation application protocol user equipment authorization request comprising an identifier of the broadcast session or service, and an identifier of the user equipment to a network entity, means for receiving a next generation application protocol user equipment authorization reply message from the network entity comprising an indication of whether the user equipment is authorized to receive the broadcast session or service, and means for, based upon the authorization indication, determining whether to take into consideration the user equipment interest indication for the broadcast session or service.

In various example embodiments, apparatus 2210 may be controlled by memory 2212 and processor 2211 to transmit a handover required message for a user equipment comprising at least one of a home PLMN identifier, an inbound roamer indication, or a multicast/broadcast interest indication configured for the user equipment.

Certain example embodiments may be directed to an apparatus that includes means for performing any of the methods described herein including, for example, means for transmitting a handover required message for a user equipment comprising at least one of a home PLMN identifier, an inbound roamer indication, or a multicast/broadcast interest indication configured for the user equipment.

In various example embodiments, apparatus 2210 may be controlled by memory 2212 and processor 2211 to receive a broadcast session start request for a broadcast session comprising roaming restriction information, and transmit at least one next generation application protocol broadcast session setup request message to a network entity configured for a broadcast session comprising the roaming restriction information.

Certain example embodiments may be directed to an apparatus that includes means for performing any of the methods described herein including, for example, means for receiving a broadcast session start request for a broadcast session comprising roaming restriction information, and means for transmitting at least one next generation application protocol broadcast session setup request message to a network entity configured for a broadcast session comprising the roaming restriction information.

In various example embodiments, apparatus 2210 may be controlled by memory 2212 and processor 2211 to receive a next generation application protocol broadcast session setup request message for a broadcast session from a core network entity comprising roaming restriction information, store the roaming restriction information for the broadcast session, receive from the core network entity at least one of a next generation application protocol initiation context setup request for a user equipment comprising a home PLMN identifier and a handover request message for a user equipment comprising a home PLMN identifier, receive an interest indication for the user equipment for the broadcast session, and determine based on the stored roaming restriction information and the home PLMN identifier of the user equipment, whether to take into consideration the user equipment interest indication for the broadcast session or service.

Certain example embodiments may be directed to an apparatus that includes means for performing any of the methods described herein including, for example, means for receiving a next generation application protocol broadcast session setup request message for a broadcast session from a core network entity comprising roaming restriction information, means for storing the roaming restriction information for the broadcast session, means for receiving from the core network entity at least one of a next generation application protocol initiation context setup request for a user equipment comprising a home PLMN identifier and a handover request message for a user equipment comprising a home PLMN identifier, means for receiving an interest indication for the user equipment for the broadcast session, and means for determining based on the stored roaming restriction information and the home PLMN identifier of the user equipment, whether to take into consideration the user equipment interest indication for the broadcast session or service.

In various example embodiments, apparatus 2210 may be controlled by memory 2212 and processor 2211 to send a handover required message for a user equipment comprising a home PLMN identifier.

Certain example embodiments may be directed to an apparatus that includes means for performing any of the methods described herein including, for example, means for sending a handover required message for a user equipment comprising a home PLMN identifier.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### Partial Glossary

| | |
|---|---|
| 3GPP | 3^{rd} Generation Partnership Project |
| 5G | 5^{th} Generation |
| 5GC | 5^{th} Generation Core |
| 6G | 6^{th} Generation |
| AF | Application Function |
| AMF | Access and Mobility Management Function |
| ASIC | Application Specific Integrated Circuit |
| CBSD | Citizens Broadband Radio Service Device |
| CPU | Central Processing Unit |
| CU | Centralized Unit |
| DU | Distributed Unit |
| eMBB | Enhanced Mobile Broadband |
| eNB | Evolved Node B |
| gNB | Next Generation Node B |
| GPS | Global Positioning System |
| HDD | Hard Disk Drive |
| HPLMN | Home Public Land Mobile Network |
| IoT | Internet of Things |
| IP | Internet Protocol |
| LTE | Long-Term Evolution |
| LTE-A | Long-Term Evolution Advanced |
| MBS | Multicast and Broadcast Systems |
| MBSF | Multicast/Broadcast Service Function |
| MB-SMF | Multicast Broadcast Session Management Function |
| MBSTF | Multicast/Broadcast Service Transport Function |
| MCCH | Multicast Control Channel |
| MEMS | Micro Electrical Mechanical System |
| MII | Multicast and Broadcast Systems Interest Indication |
| MIMO | Multiple Input Multiple Output |
| mMTC | Massive Machine Type Communication |
| MTCH | Multicast and Broadcast Systems Traffic Channel |
| NE | Network Entity |
| NEF | Network Exposure Function |
| NG | Next Generation |
| NGAP | Next Generation Application Function |
| NG-eNB | Next Generation Evolved Node B |
| NG-RAN | Next Generation Radio Access Network |
| NR | New Radio |
| PDA | Personal Digital Assistance |
| QoS | Quality of Service |
| RAM | Random Access Memory |
| RAN | Radio Access Network |
| RAT | Radio Access Technology |
| RF | Radio Frequency |
| ROM | Read-Only Memory |
| RRC | Radio Resource Control |
| SMF | Session Management Function |
| SNPN | Stand-alone Non-Public Network |
| TMGI | Temporary Mobile Group Identity |
| UDM | Unified Data Manager |
| UE | User Equipment |
| UMTS | Universal Mobile Telecommunications System |
| UPF | User Plane Function |
| URLLC | Ultra-Reliable and Low-Latency Communication |
| UTRAN | Universal Mobile Telecommunications System |
| | Terrestrial Radio Access Network |
| V-AF | Virtual Application Function |
| VPLMN | Visited Public Land Mobile Network |
| WLAN | Wireless Local Area Network |

We claim:

1. An apparatus comprising at least one processor and at least one memory storing instructions that, when executed by the at least one processor, cause the apparatus at least to:
receive, when the apparatus is attached to a public land mobile network as an inbound roamer, a service announcement for a broadcast session or service class indicating whether inbound roamers are allowed to access the broadcast service or service class;
determine, based on the service announcement, whether the apparatus is allowed to access a broadcast session or service class in the public land mobile network; and
in response to determining that the user equipment is allowed to access a broadcast session or service class in the public land mobile network, transmit a multicast/broadcast service interest indication associated with the broadcast session or service class upon completion of a radio resource request.

2. The apparatus of claim 1, wherein the apparatus is caused to determine whether the apparatus is allowed to access a broadcast session or service class in the public land mobile network based at least upon the service announcement indicating at least one home public land mobile network of allowed or disallowed inbound roamers and at least one home public land mobile network of the apparatus.

3. The apparatus of claim 1, wherein the instructions, when executed by the at least one processor, further cause the apparatus to:
in response to determining that the apparatus is allowed to access a broadcast session or service class in the public land mobile network, display an indication of whether the broadcast session or service class is accessible.

4. The apparatus of claim 1, wherein the instructions, when executed by the at least one processor, further cause the apparatus to:
receive a multicast/broadcast service interest indication allowed notification or multicast/broadcast service interest indication disallowed notification associated with the broadcast session or service class.

5. An apparatus comprising at least one processor and at least one memory storing instructions that, when executed by the at least one processor, cause the apparatus at least to:
determine whether a broadcast session or service class is accessible by inbound roamers; and
in response to determining that a broadcast session or service class is accessible by inbound roamers, transmit a service announcement for a broadcast session or service class indicating whether inbound roamers are allowed to access the broadcast service or service class.

6. The apparatus of claim 5, wherein the service announcement further indicates at least one home public land mobile network of allowed or disallowed inbound roamers.

7. The apparatus of claim 5, wherein the determination is based at least upon configured information.

8. The apparatus of claim 5, wherein the instructions, when executed by the at least one processor, further cause the apparatus to:
transmit a request for establishment of the broadcast session or service to a network entity, the request comprising an indication of whether inbound roamers are allowed to access the broadcast session or service.

9. The apparatus of claim 5, wherein the instructions, when executed by the at least one processor, further cause the apparatus to:
receive a response to a request comprising a second indication of whether inbound roamers are allowed to access the broadcast session or service,
wherein the apparatus is caused to determine whether a broadcast session or service class is accessible by inbound roamers based at least upon the second indication.

10. The apparatus of claim 9, wherein the request indicates at least one service class.

11. An apparatus comprising at least one processor and at least one memory storing instructions that, when executed by the at least one processor, cause the apparatus at least to:
receive a request for the establishment of a broadcast session or service from a network entity;
determine whether inbound roamers are allowed to access the broadcast session or service; and
transmit a response to the request indicating whether inbound roamers are allowed to access the broadcast session or service.

12. The apparatus of claim 11, wherein the request indicates at least one service class.

13. The apparatus of claim 12, wherein the apparatus is caused to determine whether inbound roamers are allowed to access the broadcast session or service based upon at least one of:
an identity of the network entity;
the at least one service class;
configured information; or
information obtained from a database.

14. The apparatus of claim 11, wherein the instructions, when executed by the at least one processor, further cause the apparatus to:
transmit a request to establish or start the broadcast session or service comprising an indication of whether inbound roamers are allowed to access the broadcast session or service.
